(19) United States
(12) Patent Application Publication
(10) Pub. No.: US 2026/0359679 A1
(43) Pub. Date: Nov. 12, 2026

(54) METHODS, SYSTEMS, AND APPARATUSES FOR IMPROVED MULTIVARIATE TIME SERIES FORECASTING

(71) Applicant: QlikTech International AB, Lund (SE)

(72) Inventors: Sudamsh Reddy, Salt Lake City, UT (US); Pedro Fillastre, Salt Lake City, UT (US); Mehran Bagheri, Salt Lake City, UT (US); Johan Persson, Lund (SE); Yvonne Hedberg, Lund (SE)

(21) Appl. No.: 19/675,079

(22) Filed: May 12, 2026

Related U.S. Application Data
(60) Provisional application No. 63/804,427, filed on May 12, 2025.

(51) Int. Cl. G06N 5/04

(52) U.S. Cl. CPC G06N 5/04

(57) ABSTRACT

The present disclosure relates to multivariate time series forecasting. A dataset comprising row-wise time-stamped records may be received. Through a user interface, a selection of a target value, a date index, and a time series experiment type may be received. Based on the selection, the records may be transformed into sequential training examples without user data preparation. As part of this transformation, the records may be sorted by the date index and segmented by one or more group identifiers. Input-output sequences may then be generated based on an apply window length and a forecast window. Using the sequential training examples, a trained multivariate time series forecasting model may be generated and deployed as a forecasting service. A natural language query requesting a forecast may be received at an assistant application, which may invoke the forecasting service and return a response comprising the forecast. Cross-series relationships may be learned, enabling scenario analysis across related series.

### CROSS-REFERENCE TO RELATED PATENT APPLICATION

This application claims priority to U.S. Prov. App. No. 63/804,427, filed on May 12, 2025, the entirety of which is incorporated by reference herein.

### BACKGROUND

Time series forecasting may be used across various domains to predict future values based on historical data. Automated machine learning systems have improved access to predictive modeling by abstracting model selection and hyperparameter tuning. However, many automated machine learning workflows may treat input data as static tabular rows and may not expose temporal constructs for sequence modeling. These and other considerations are discussed herein.

### SUMMARY

It is to be understood that both the following general description and the following detailed description are exemplary and explanatory only and are not restrictive. The present disclosure relates to multivariate time series forecasting. A dataset comprising a plurality of row-wise time-stamped records may be received, where each record may comprise a timestamp, a target value, and one or more predictor values. Through a user interface, a selection of the target value, a date index, and a time series experiment type may be received. Based on the selection, the plurality of row-wise time-stamped records may be transformed into a plurality of sequential training examples without user data preparation. As part of this transformation, a sorted order of the records may be determined based on the date index. From the sorted records, one or more group identifiers may be used to determine a plurality of segments. A plurality of input-output sequences may then be generated from the segments based on an apply window length and a forecast window. Additionally, one or more future features comprising feature values known in advance for one or more future time steps may be selected via the user interface.

Using the sequential training examples, a trained multivariate time series forecasting model may be generated. A selected model may be determined from a plurality of candidate models based on one or more performance metrics. Once selected, deployment of the trained model as a forecasting service may be caused. In operation, a natural language query requesting a forecast may be received at an assistant application. In response, a forecast may be generated by causing the assistant application to invoke the forecasting service. A response comprising the forecast may then be sent by the assistant application, and a visualization of the forecast may also be provided. Furthermore, cross-series relationships among multiple related series may be learned by the model, thereby enabling scenario analysis to be performed by modifying one or more future feature values and observing resulting changes across one or more related series. Contextual information may also be retrieved from a vector database and used by a large language model to formulate a response.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A illustrates an operating environment.

FIG. 1B illustrates a system for data processing and natural language querying.

FIG. 2 illustrates a user interface for data visualization and analysis.

FIG. 3 illustrates a temporal framework for time series forecasting.

FIG. 4A illustrates a training table used during a training phase.

FIG. 4B illustrates a predictions phase with an apply table and a prediction table.

FIG. 5 illustrates an experiment-configuration interface.

FIG. 6A illustrates an experiment configuration interface.

FIG. 6B illustrates an experiment configuration screen with a date index selector.

FIG. 7A illustrates a training-status interface.

FIG. 7B illustrates a model-summary interface.

FIG. 7C illustrates an analytics application with a predictions dashboard.

FIG. 7D illustrates a dashboard view with product demand predictions.

FIG. 7E illustrates a scenario view for scenario analysis.

FIG. 8A illustrates a system for training prediction models.

FIG. 8B illustrates a process for training a machine learning model.

FIG. 9 illustrates a computing environment.

FIG. 10 illustrates a method for multivariate time series forecasting.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

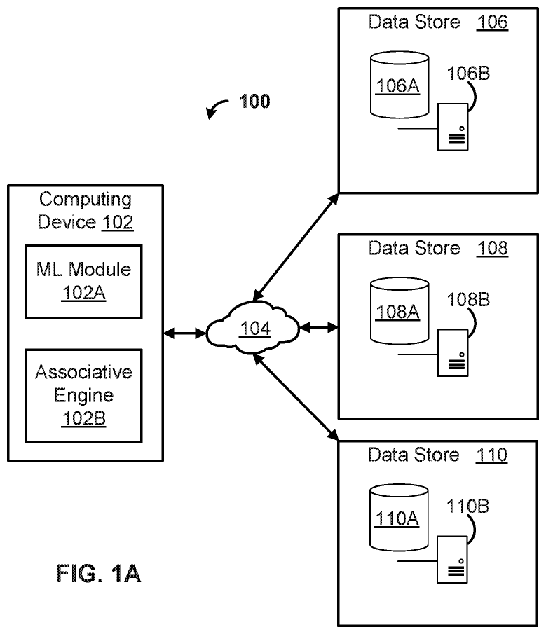

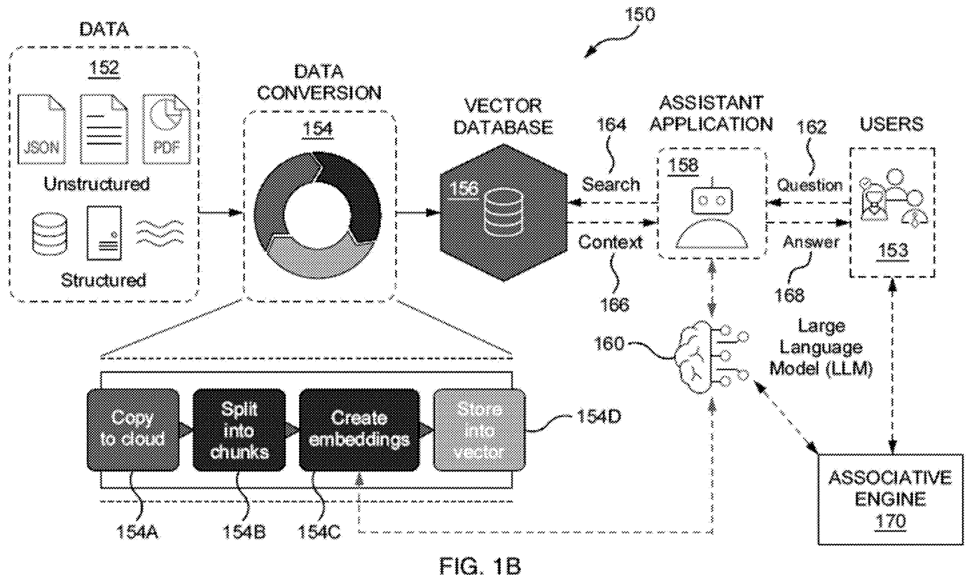

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102.

The system 100 may implement one or more forecasting functions, including data ingestion, temporal preprocessing, sequence-window construction, model training, validation, model selection, model deployment, forecast serving, a combination thereof, and/or the like. For example, the system 100 may receive a dataset comprising a plurality of row-wise time-stamped records and may automatically transform the row-wise time-stamped records into sequential training examples without requiring manual data reshaping by a user. This automatic transformation addresses a technical problem rooted in computer technology: row-wise time-stamped records stored in tabular format are not natively structured for consumption by sequence-model architectures, which require fixed-length or variable-length tensor representations with temporally ordered input-output pairs. Conventional approaches to this problem require scripting, custom data reshaping, manual tensor construction, and model-specific configuration, all of which are computationally distinct from the forecasting task itself and that impose a technical barrier to efficient pipeline construction. The system 100 addresses this technical problem by automatically sorting, segmenting, and windowing the tabular records into sequential representations suitable for one or more candidate sequence models, thereby eliminating the manual engineering steps that would otherwise be required. As used herein, a ‘row-wise time-stamped record’ refers to a data record in which each row corresponds to a single observation at a particular point in time. Each row-wise time-stamped record may comprise a timestamp, a target value, and one or more predictor values. Other examples are possible as well.

As used herein, a ‘sequential training example’ refers to an input-output sequence derived from row-wise time-stamped records, comprising an input portion spanning an apply window and an output portion spanning a forecast window. The input portion may include historical records covering a selected number of recent time steps. The output portion may include target values for one or more future time steps. A plurality of sequential training examples may be generated by sorting the row-wise time-stamped records according to a date index, segmenting the sorted records by one or more group identifiers, and generating input-output sequences from the resulting segments based on an apply window length and a forecast window.

As used herein, a ‘date index’ refers to a date or timestamp field in a dataset that defines time ordering for training and inference, and a ‘group identifier’ refers to one or more values that distinguish separate but potentially related time series within a dataset, such as a store identifier, a product identifier, a region, a customer segment, an asset identifier, a channel designation, a combination thereof, and/or the like. Further, as used herein, an ‘apply window’ refers to a selected number of recent time steps supplied to a model at inference time as historical context; ‘forecast window’ refers to one or more future time steps for which a model is configured to output predictions; and a ‘time step’ refers to the interval between successive records in a sequence, such as a day, a week, a month, an hour, another temporal granularity, a combination thereof, and/or the like. Other examples are possible as well.

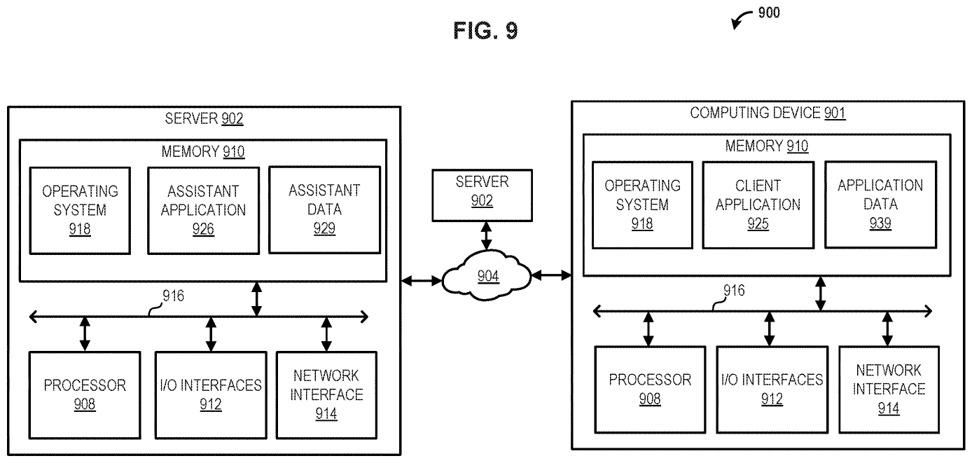

As further described herein, the system 100 may train one or more multivariate time series forecasting models using the sequential training examples and may deploy a selected model for batch or real-time use. The trained multivariate time series forecasting model may be stored by one or more of the servers 106B, 108B, 110B in one or more of the databases 106A, 108A, 110A and/or in the supplemental repositories of the data stores 106, 108, 110. The trained model may be accessible to the computing device 102, the assistant application 158 of the system 150, and/or the client application 925 of FIG. 9 via the network 104.

The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide near-instantaneous calculation of aggregates, selections, and filters as further described herein.

Each of the plurality of data stores 106, 108, 110 may comprise one or more data storage mechanisms, such as a relational database, a cloud data warehouse, an object store, a search index, a vector database, an application repository, a file system, a software-as-a-service platform, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism. In some aspects, the plurality of data stores 106, 108, 110 may include structured repositories storing row-wise historical records used for model training and inference, including timestamps, target values, predictor values, group identifiers, known future schedules, a combination thereof, and/or the like. The plurality of data stores 106, 108, 110 may also include supplemental repositories storing documentation, calendars, scenario files, business rules, model metadata, deployment artifacts, other content used by a forecasting platform, a combination thereof, and/or the like.

The network 104 may facilitate communication between the plurality of data stores 106, 108, 110 and the computing device 102. The network 104 may include one or more local-area networks, wide-area networks, cloud networks, virtual private networks, optical fiber networks, cellular networks, wireless networks, a combination thereof, and/or the like. The network 104 may support secure connectivity to source systems, data connections, scheduled refresh operations, event-driven triggers, real-time application programming interfaces, and machine-to-machine communications. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a data analytics platform, a data warehouse, a customer relationship management system, or other types of systems. This integration may allow the system 100 to access additional data, provide more comprehensive insights, or offer additional features to the users. For example, the system 100 may aggregate data from multiple sources, align the data using one or more timestamps and group identifiers, and construct a unified training dataset for one or more multivariate forecasting experiments. The system 100 may also expose one or more interfaces by which dashboards, external planning systems, or assistant applications can request forecasts from a deployed forecasting model. In some aspects, the system 100 may include containerized services, orchestration platforms, serverless functions, message queues, streaming systems, or specialized hardware accelerators such as graphics processing units, tensor processors, or inference accelerators. The disclosed methods may be deployed in a multitenant cloud environment, a private cloud, an on-premises installation, or a hybrid environment. Other examples are possible as well.

Turning now to FIG. 1B, an example system 150 is shown. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown). As shown in FIG. 1B, the system 150 may further comprise an associative engine 170. The associative engine 170 may correspond to the AE module 102B of the computing device 102 shown in FIG. 1A. The associative engine 170 may store one or more data models in-memory and manage associations between data elements, providing near-instantaneous calculation of aggregates, selections, and filters.

In some aspects, the system 100 may construct a source dataset by aggregating data from a plurality of data sources, each of which may be resident at one or more of the data stores 106, 108, 110 or accessible via the network 104. The system 100 may align the aggregated data using one or more common fields, such as a common date index, one or more common group identifiers, or both. As part of the alignment, the system 100 may normalize one or more timestamps across the plurality of data sources to a common time zone, a common calendar, a common temporal granularity, a combination thereof, and/or the like. The system 100 may resolve one or more conflicts between data sources by applying one or more conflict-resolution rules, such as preferring a designated authoritative source, preferring a most-recently-updated source, computing an aggregate of conflicting values, surfacing the conflict for user resolution, a combination thereof, and/or the like. The system 100 may further use the associative engine 170 to maintain associations between fields across the plurality of data sources, such that one or more selections made on a field originating in a first data source propagate to one or more associated fields originating in a second data source. Once aligned, the aggregated data may be stored as a unified training dataset for one or more multivariate forecasting experiments. Other examples are possible as well.

In some aspects, the associative engine 170 may implement associative selection propagation. When a user 153 makes a selection in an application, the associative engine 170 may instantly perform logical inference across an entire data model, determining what is possible, what is related, and what is not. Every visualization, every number, and every data point in an entire application may update simultaneously to reflect a new context. The associative engine 170 may provide deterministic calculations such that the same query run multiple times returns the same result. This deterministic behavior may be independent of any large language model processing, such as processing by the LLM 160. The associative engine 170 may reveal not just “what is” but also “what is not” by identifying excluded values that are not related to a current context.

At its core, the associative engine 170 (which may correspond to the AE module 102B of the computing device 102 shown in FIG. 1A) may perform a transformation during data loading. Instead of storing data as traditional rows and columns, the associative engine 170 may create two distinct structures: data tables and symbol tables. Symbol tables may contain one row per distinct value for each field, acting as lookup tables. The actual data tables may contain the same structure as a traditional database, but instead of data, they may contain only bit-stuffed pointers that are indices pointing back to the symbol tables. The bit-stuffed pointers may be compressed, using only the exact number of bits needed to represent the distinct values in each field. If a field has four distinct values, the pointer may be only two bits long. If a field has 256 distinct values, the pointer may use eight bits. This bit-stuffing may create compression while maintaining fidelity. In the associative engine 170, columns may not be typed in the manner of a regular database. Instead, each cell may be typed, using only the memory needed.

The associative engine 170 may maintain state vectors. The state vectors may be binary arrays that track the status of every data point and field value in an application. When selections are made by the user 153, the state vectors may instantly update to reflect which field values are selected, possible, alternative, or excluded, which records in data tables are included in a current context, which calculations need to be updated, and what relationships exist in a current state. This state management system may enable the associative engine 170 to maintain global context across an entire application while supporting performance even with complex selections and large datasets stored in the data stores 106, 108, 110.

For calculations and visualizations, the associative engine 170 may use hypercubes. Hypercubes may be dynamic, multi-dimensional data structures that organize information for analytical computation. Hypercubes may handle complex aggregations across multiple dimensions simultaneously. Hypercubes may be created on-demand based on specific analytical needs, may handle millions of data points, and may be optimized for the types of calculations that drive analytics. The associative engine 170 may use logical inference before any calculations occur to determine which data is relevant to current selections. This logical inference may happen virtually instantaneously because there is no number crunching involved, just logical evaluation of relationships. Once logical inference determines the relevant data set, calculation engines may compute analytics in real-time using advanced techniques including hypercubes and multithreading.

The associative engine 170 may excel in artificial intelligence scenarios because context retention may permit the LLM 160 building complex reasoning chains, high-speed calculation may support rapid hypothesis testing, complete data access may ensure AI models (e.g., the ML module 102A shown in FIG. 1A) have full information, relationship visibility may help AI understand data connections, and governed calculations may provide trustworthy results for automated decisions. The associative engine 170 may retain context across multiple questions 162, refining and recontextualizing after every interaction.

The technical improvements provided by the associative engine 170 may address specific technical problems in the field of data analytics. Traditional analytics tools may create tunnel vision where a user 153 writes a query, gets a result set, and sees only what matches specific criteria, while everything else including context, relationships, and the broader story disappears. Traditional approaches may result in data being left behind because SQL joins force selection of primary and secondary data sources, exploration being restricted to pre-built reports and dashboards, questions 162 needing to be anticipated in advance making discovery nearly impossible, performance suffering because each new question requires hitting the database again, and context being lost because related information does not stay connected. The associative engine 170 may provide a technical solution to these technical problems by maintaining global context across an entire application, performing deterministic calculations that are traceable and reproducible, and enabling exploration without requiring predefined queries or reports. The in-memory data structures, bit-stuffed pointers, state vectors, and hypercube calculations described herein represent specific technical implementations that improve the functioning of computer systems (e.g., the computing device 102 of the system 100 shown in FIG. 1A) for data analytics.

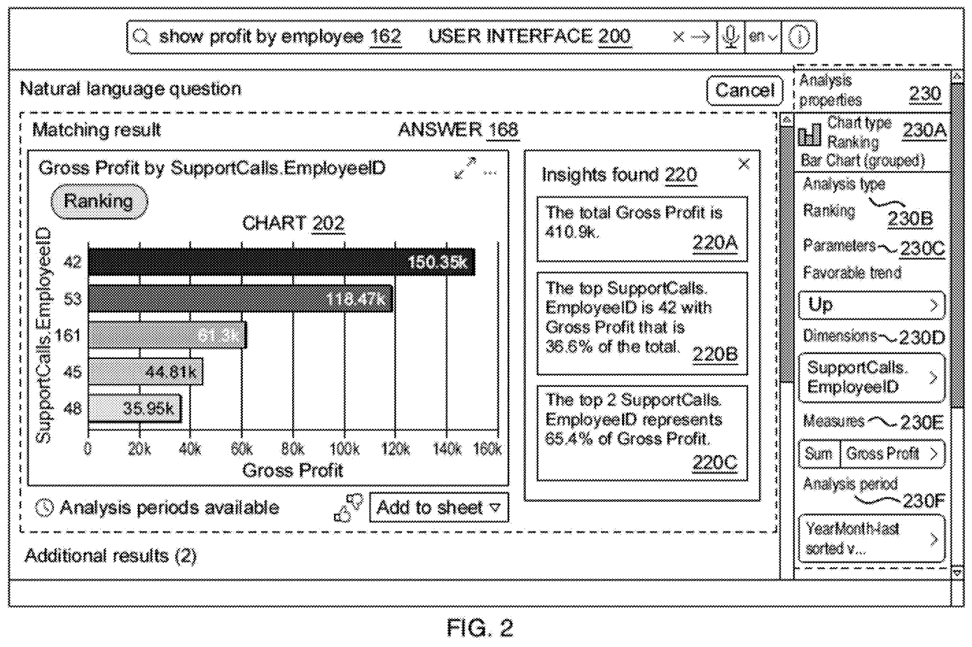

In some aspects, the associative engine 170 may identify, based on a current selection state, one or more excluded values that are not associated with the current selection state but are associated, in a data model maintained by the associative engine 170, with one or more selected values. The system 150 may use the identification of excluded values to invoke a forecasting service (described further herein) to obtain one or more additional predicted target values for the one or more excluded values. For example, if a user 153 has selected a particular product category, the associative engine 170 may identify one or more related products that are excluded from the current selection but are associated with the selected category in the data model. The system 150 may invoke the forecasting service to generate forecasts for the excluded-but-related products and may surface the one or more additional predicted target values via a user interface (e.g., the user interface 200 of FIG. 2). This exclusion-state-aware forecasting may enable the user 153 to discover hidden analytical value in data excluded by the user's current filters. The assistant application 158 may present the additional forecasts alongside the primary forecast, enabling the user 153 to compare predicted values for selected and excluded-but-related series. Other examples are possible as well.

In some aspects, the system 150 may be utilized to transform both structured and unstructured enterprise content into machine-consumable representations. Structured content may include analytics applications, dashboards, business logic, logical models, master measures, master dimensions, field descriptions, bookmarks, stories, expressions, reusable visual assets, security rules, application metadata, data models, semantic objects associated with one or more analytical applications, etc. Unstructured content may include documents, presentations, HTML files, text files, portable document format files, mail archives, transcripts, tickets, knowledge articles, support records, code repositories, media transcripts, and other file-based content. In some aspects, the structured content may further include forecast results, experiment configuration metadata, model cards, scenario templates, calendars, business notes, other material relevant to a forecasting workflow, a combination thereof, and/or the like.

The data 152 may be split into manageable chunks in a data conversion process 154. At step 154A, the data 152 may be copied, linked, or otherwise registered for indexing. Source content may be registered without requiring the entire underlying source content to be persisted in the same environment as the assistant application 158. Source materials may be refreshed manually, on a schedule, based on deltas, in response to events, or according to other synchronization policies. At step 154B, the data 152 may be split into chunks (e.g., portions of text data). A document may be segmented by sentence, paragraph, heading, or semantic boundary. A transcript may be segmented by speaker turn or time interval. An analytical application may be segmented according to measures, dimensions, master items, dashboard objects, sheets, or semantic objects. A load script or expression may be segmented according to script block, transformation step, or expression boundary. Chunk sizes may vary according to complexity, token budget, expected retrieval granularity, or computational resources. Other examples are possible as well.

Once the data is split into chunks, each chunk may be converted into an embedding at step 154C. Embeddings may be created using one or more machine-learning models (e.g., LLM 160), such as large language models, transformer models, recurrent neural networks, convolutional neural networks, sentence-embedding models, multimodal models, autoencoders, or dimensionality-reduction methods. Different embedding models may be used for different source types. The system 150 may generate separate representations for raw source text, curated master items, synonyms, descriptions, and logical-model entities, and may assign different weights to such representations during subsequent retrieval. For example, embeddings associated with curated master items may be weighted more heavily than embeddings associated with raw source text during retrieval operations.

In some examples, at step 154C, each chunk may be converted into an embedding via LLM 160 in FIG. 1B (e.g., resident at and/or within the control of the ML module 102A). Each embedding may comprise a numerical representation of the corresponding chunk of the data 152 that may be consumed/used by an LLM(s) (e.g., by the LLM 160). Traditional word embedding models like Word2Vec, GloVe (Global Vectors for Word Representation), or FastText can also be used to generate vector representations of words or phrases. The choice of model depends on factors such as the nature of the data, the specific requirements of the task, and the available computational resources. Other examples are possible as well.

At step 154D, the embeddings may be stored in a vector database 156 (e.g., resident at and/or controlled by any of the data stores 106, 108, 110). The vector database 156 may semantically index the content and maintain references back to original sources. The vector database 156 may store metadata such as access permissions, source type, source timestamp, indexed date, tenant or workspace identifier, application identifier, object identifier, semantic tags, or ranking weights. The vector database 156 may be used in combination with a re-ranking service, a keyword index, a graph traversal engine, or a rules engine to improve retrieval quality.

In some aspects, the system 150 may maintain separate or partially separate indexes for structured and unstructured data while still supporting hybrid retrieval. A structured-application index may emphasize business logic, measures, dimensions, master items, visual objects, a combination thereof, and/or the like. An unstructured knowledge-base index may emphasize document passages, article fragments, ticket histories, transcript excerpts, a combination thereof, and/or the like. In response to a given question, the system 150 may retrieve from one index, the other index, or both, and may merge or reconcile the resulting context based on confidence, permissions, ranking scores, or answerability criteria. Curated semantic artifacts such as master measures, master dimensions, or business-logic entities may be weighted more heavily than raw source fields during question interpretation or result ranking to reduce ambiguity and increase answer fidelity. Other examples are possible as well.

After embeddings are generated and semantically indexed in the vector database 156, an assistant application 158 (e.g., resident at and/or controlled by any of the servers 106B, 108B, 110B), such as a natural language (“NL”) assistant, agent, and/or a chatbot, may provide answers to queries related to the data 152. The assistant application 158 may interact with the LLM 160 to process natural language queries from one or more users 153. The system 150 may further support predictive services, anomaly-detection services, proactive discovery services, etc. For example, the assistant application 158 may request a real-time predictive score, a forecast, or a feature-importance explanation from a predictive model. A predictive output may comprise a classification, a regression result, a time-series forecast, an anomaly indication, a feature-importance explanation, a contribution score, a SHAP-like explanation, a what-if scenario analysis, real-time prediction results, a combination thereof, and/or the like.

In a forecasting implementation, the assistant application 158 may convert natural language requests into parameterized forecasting requests, such as a request for a specific product, region, horizon, or scenario modification. The assistant application 158 may invoke a deployed forecasting service to obtain fresh forecast values and may merge retrieved context 166 and model output into a natural language response. As used herein, a ‘forecasting service’ refers to a deployed model endpoint configured to receive input data and return predicted target values for one or more future time steps. Put differently, ‘forecasting service’ refers to a set of operations performed by one or more entities of the system 100 of FIG. 1A and/or the system 150 of FIG. 1B to receive input data and return predicted target values for one or more future time steps. For example, a user 153 may ask the assistant application 158 how popular a product will be next month, and the assistant application 158 may invoke the forecasting service, receive predicted demand values, and present the forecast as a line chart and a natural language summary. Other examples are possible as well.

In some aspects, the parameterized forecasting request may be generated based on a current selection state maintained by the associative engine 170. The associative engine 170 may maintain one or more state vectors that identify, for each of a plurality of fields of the dataset, values that are at least one of selected, possible, alternative, or excluded based on one or more user selections. When the assistant application 158 converts a natural language query into a parameterized forecasting request, the assistant application 158 may query the associative engine 170 to obtain the current selection state. The parameterized forecasting request may be informed by one or more values identified as selected by the one or more state vectors. For example, if a user 153 has previously selected a particular region or product category in an analytics application, the associative engine 170 may provide this selection context to the assistant application 158, which may then include the selected region or product category in the parameterized forecasting request without requiring the user 153 to re-specify these parameters in the natural language query. The current selection state may also inform which group identifiers, which future feature values, and which historical records are included in the parameterized forecasting request. Other examples are possible as well.

In the context of the system 100, the forecasting service may be implemented by one or more of the servers 106B, 108B, 110B and/or the computing device 102 executing the ML module 102A. The forecasting service may encompass a trained multivariate time series forecasting model packaged with associated preprocessing logic, temporal configuration parameters, and serving infrastructure. The temporal configuration parameters may include a date index, a forecast window, a forecast gap, an apply window length, one or more group identifiers, and one or more future feature designations. Model artifacts, such as trained model weights, feature encodings, and scaling parameters, may be stored by one or more of the servers 106B, 108B, 110B in one or more of the databases 106A, 108A, 110A and/or in the supplemental repositories of the data stores 106, 108, 110. In the context of the system 150 of FIG. 1B, the assistant application 158 may access the forecasting service via one or more APIs exposed by the servers 106B, 108B, 110B.

The assistant application 158 may invoke the forecasting service by transmitting a request comprising one or more group identifiers, recent historical records spanning an apply window, and future feature values spanning a forecast gap and a forecast window. One or more of the servers 106B, 108B, 110B and/or the computing device 102 may process the request by applying the historical records and the future feature values to the trained multivariate time series forecasting model, and may return one or more predicted target values, and optionally one or more uncertainty values or prediction intervals, to the assistant application 158. For example, a user 153 may ask the assistant application 158 how popular a product will be next month, and the assistant application 158 may invoke the forecasting service, receive predicted demand values, and present the forecast as a line chart and a natural language summary.

In some aspects, invoking the forecasting service may comprise receiving, from the associative engine 170, one or more aggregated predictor values computed using a hypercube data structure. The hypercube data structure may be organized by at least one of the one or more group identifiers and a temporal dimension defined by the date index. The associative engine 170 may compute the one or more aggregated predictor values by applying one or more aggregation operations, such as a sum, an average, a count, a minimum, a maximum, a weighted average, a combination thereof, and/or the like, across the hypercube data structure. The one or more aggregated predictor values may be provided as input to the trained multivariate time series forecasting model. For example, when a natural language query requests a forecast at a higher level of aggregation than the level at which the model was trained, the associative engine 170 may use the hypercube data structure to aggregate historical predictor values and future feature values to the requested level prior to invoking the forecasting service. The hypercube-based aggregation may enable the forecasting service to generate forecasts at multiple levels of granularity without requiring separate models for each aggregation level. Other examples are possible as well.

The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for processing structured data related to natural language queries, the system 150 may determine and structure a comprehensive set of data and metadata from each corresponding app(s). This data may form a foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

A data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. The system 150 may enforce row-level, column-level, object-level, and/or application-level permissions. The system 150 may apply space-based or tenant-based access rules, as examples. The system 150 may filter outputs according to role or entitlement as well. The system 150 may log provenance and lineage. The system 150 may sanitize secrets and personally identifiable information. The system 150 may detect or reject prompt-injection attempts. The system 150 may constrain model invocation according to processing-location policies. The system 150 may prevent the assistant application 158 from surfacing source material not authorized for the requesting user. Other examples are possible as well.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency. Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153). Other examples are possible as well.

The system 150 may be capable of triggering actions and automated processes based on insights derived from user queries. In some cases, the assistant application 158 may analyze the natural language question 162 and the generated answer 168 to identify potential actions. The assistant application 158 may then initiate these actions through appropriate components of the system 150 or external systems. For example, if a natural language question 162 relates to a specific data trend, the system 150 may not only provide an answer 168 describing the trend but may also trigger an automated process to generate a detailed report or alert relevant stakeholders.

The interaction between the users 153, the assistant application 158, and the large language model 160 may be iterative. In some cases, the system 150 may engage in a multi-turn conversation with the users 153, refining and expanding upon the initial natural language question 162 and answer 168. This iterative process may allow for more comprehensive and accurate responses to complex queries. In a forecasting context, and as further described herein, the assistant application 158 may identify a previously generated forecast, explain why a forecast was produced, recommend one or more experiment settings, summarize scenario results, and/or initiate a live call to a deployed forecasting service to obtain updated forecast values responsive to a natural language question 162. Other examples are possible as well.

Turning now to FIG. 2, an example user interface 200 is shown. The user interface 200 may provide an interactive environment for users to engage with for natural language processing. In some aspects, the user interface 200 may also provide an interactive environment for configuring, training, deploying, and consuming multivariate time series forecasts. The user interface 200 may receive natural language analytical objectives from users and display results. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. As examples, users may enter natural language analytical objectives such as “How should I allocate marketing budget across regions to maximize revenue?” or “What drives sales in the Northeast?” The question 162 may be processed by the assistant application 158 as described in relation to FIG. 1B.

The question 162 input field may support various types of queries, ranging from simple data requests to complex analytical questions including optimization problems, causal inference questions, etc. Users may ask questions such as “What were the top products last quarter?” or “Show me sales trends by region.” The system may interpret these natural language inputs and convert them into appropriate data operations. In a forecasting context, users may enter natural language queries such as ‘How popular will avocados be next month?’ or ‘What happens to avocado demand if we run a promotion on chips?’ The systems 100 and/or 150 may interpret these forecasting-related queries and invoke a deployed forecasting service to generate fresh forecast values or scenario-adjusted forecasts as further described herein.

The user interface 200 may also display an answer 168 in response to the user's question 162. The answer 168 may comprise natural language text that provides insights, explanations, and interpretations of the data. The answer 168 may be generated using the large language model(s) 160 and may incorporate contextual metadata from the associative engine 170, including exclusion state information that enables the system to identify hidden analytical value in data excluded by the user's current filters, which may form a portion of the question 162. The natural language response (answer 168) may be tailored to the user's specific query and may include relevant details, comparisons, and observations about the data. In a forecasting implementation, the answer 168 may include a forecast for one or more future time steps, a visualization of predicted values overlaid with historical values, a scenario-adjusted forecast reflecting modified future feature values, and/or an explanation of cross-series relationships learned by a multivariate time series forecasting model.

A chart 202 may be displayed within the user interface 200. The chart 202 may provide a visual representation of data relevant to the user's query or the current analytical context. The chart 202 may be generated based on data retrieved from the associative engine 170 and/or from the vector database 156. The chart 202 may be interactive, allowing users to click on specific elements to request additional insights or explanations. The chart 202 may be a visual representation of data relevant to the user's query or the current context of analysis. In some aspects, the chart 202 may display a time series line chart overlaying historical demand and predicted demand for a selected product or group. The chart 202 may also display bar charts showing predicted demand at category and product levels. Other examples are possible as well.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated by the system 150 based on the data represented in the chart 202, the user's query, and/or other contextual information including exclusion state data from the associative engine 170. Each of these insights may provide different perspectives or analyses of the data.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. In some aspects, the analysis properties 230 may include optimization parameters, constraint specifications, causal effect estimates, and exclusion impact metrics.

The analysis properties 230 may be derived from the contextual metadata provided by the associative engine 170 and may include information such as current selection states, exclusion states for field values, hypercube data, statistical measures, comparative values, a combination thereof, and/or the like. In a forecasting context, the analysis properties 230 may include a chart type selector 230A, an analysis type selector 230B, a parameters section 230C, a dimensions section 230D, a measures section 230E, and an analysis period selector 230F. The parameters section 230C may include forecast window, forecast gap, apply window length settings, a combination thereof, and/or the like. The dimensions section 230D may include one or more group identifiers. The measures section 230E may include a target variable and one or more predictor values. Other examples are possible as well.

The analysis properties 230 may serve multiple purposes within the system. They may provide the factual foundation for the natural language insights, ensuring that the generated text is grounded in actual data rather than hallucinated information. The analysis properties 230 may also be used to construct prompts for the large language models, providing the necessary context and data points for generating accurate and relevant responses. Additionally, the analysis properties 230 may be used to determine appropriate visualizations and to guide the narrative structure of the insights. Other examples are possible as well.

The user interface 200 may support interactive exploration of data. Users may click on elements of the chart 202 to request explanations or additional insights about specific data points. The system may respond to these interactions by generating new insights or by providing more detailed analysis of the selected elements. For example, the chart 202 and the insights 220 may be dynamically updated based on user interactions. For example, if a user selects a particular bar in the chart 202, the system 150 may generate new insights specific to that selection. This interactive capability may be facilitated by the associative engine 170 and/or the LLM 160, each of which can quickly retrieve and analyze relevant data based on user selections.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user's query, while the associative engine 170 may perform real-time calculations and data retrievals to support the insights and visualizations. Other examples are possible as well.

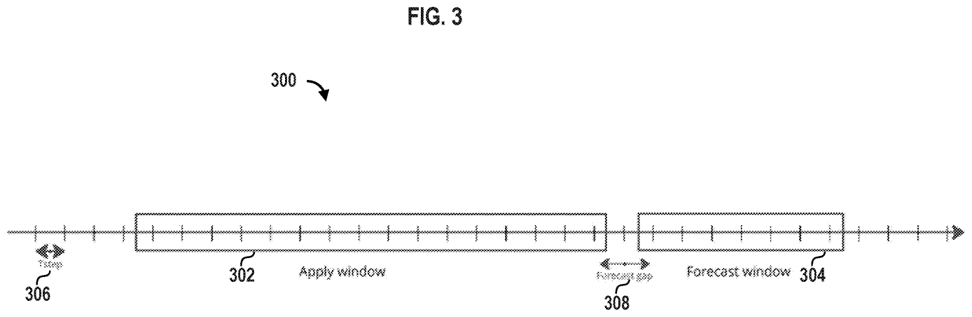

Turning now to FIG. 3, a temporal framework 300 for time series forecasting is shown. The temporal framework 300 may define temporal relationships used when transforming row-wise time-stamped records into sequential training examples. The temporal framework 300 may include an apply window 302, a forecast window 304, a time step 306, and a forecast gap 308.

The apply window 302 may span a selected number of historical time steps. The apply window 302 may provide a model with recent context during inference. For example, the apply window 302 may include recent historical records used as input to a trained multivariate time series forecasting model stored by one or more of the servers 106B, 108B, 110B in one or more of the databases 106A, 108A, 110A. The apply window 302 may have a length measured in time steps 306. In some aspects, the apply window length may be automatically set to a multiple of the forecast window 304. For example, the apply window length may be set to two times the forecast window 304. In some aspects, the system 100 may validate whether sufficient historical data exists to support a proposed apply window configuration.

The time step 306 may refer to the interval between successive records in a sequence. The time step 306 may correspond to a day, a week, a month, an hour, another temporal granularity, a combination thereof, and/or the like. In some aspects, the time step 306 may be inferred from data. For example, the ML module 102A may analyze timestamps in a dataset and determine an appropriate time step 306 based on the intervals between successive records. In some aspects, the time step 306 may be configured by a user. For example, a user may specify a daily, weekly, or monthly granularity through a user interface.

The forecast window 304 may span a selected number of future time steps for which predictions are to be generated. The forecast window 304 may define the prediction horizon of a multivariate time series forecasting model executed by one or more of the servers 106B, 108B, 110B and/or the computing device 102. For example, a forecast window 304 of twelve time steps may cause the model to generate predictions for twelve future time steps.

The forecast gap 308 may represent an offset between the end of the apply window 302 and the start of the forecast window 304. As used herein, a ‘forecast gap’ refers to a number of time steps between the end of an apply window and the beginning of a forecast window. The forecast gap 308 may be measured in time steps 306. In some aspects, the forecast gap 308 may accommodate reporting delays. For example, data for recent time steps may not yet be available due to processing latency. In some aspects, the forecast gap 308 may accommodate procurement lead times. For example, predictions may need to begin after a period required to act on forecast results. In some aspects, the forecast gap 308 may accommodate operational lag. For example, business processes may require advance notice before implementing changes based on forecasts. In some aspects, the forecast gap 308 may accommodate other situations in which predictions begin after one or more intervening time steps. Other examples are possible as well.

The system (e.g., via one or more of the servers 106B, 108B, 110B, the computing device 102, the vector database 156, the assistant application 158, the LLM 160, etc.) may transform a plurality of row-wise time-stamped records into a plurality of sequential training examples without user data preparation. As used herein, ‘user data preparation’ refers to manual data reshaping, manual tensor construction, or model-specific configuration performed by a user to arrange data into a format suitable for model training. As part of this transformation, the system may generate, based on an apply window length and a forecast window, a plurality of input-output sequences from a plurality of segments. The apply window 302 may define the input portion of each input-output sequence. The input portion may include historical records spanning the apply window length. The forecast window 304 may define the output portion of each input-output sequence. The output portion may include target values for future time steps within the forecast window 304. And the forecast gap 308 may define an offset between the input portion and the output portion of each input-output sequence, as examples.

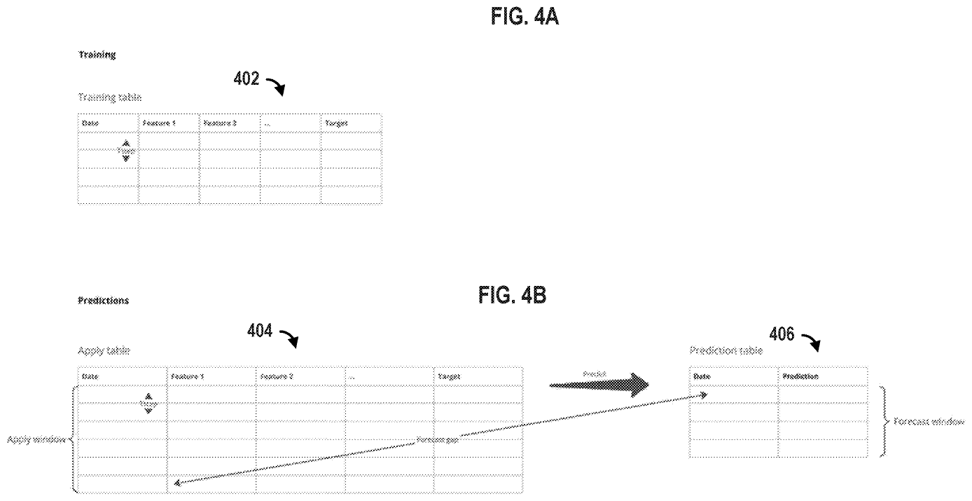

Turning now to FIG. 4A, a training table 402 is shown. The training table 402 may be used during a training phase for a multivariate time series forecasting model. The training table 402 may contain time-ordered records used to train the multivariate time series forecasting model. The training table 402 may include a date field, one or more feature fields, and a target field. The date field may correspond to the date index described above with respect to FIG. 3. The one or more feature fields may include observed historical predictors. In some aspects, the one or more feature fields may include historical instances of one or more future features. The target field may correspond to the target value selected via the user interface 200 of FIG. 2.

The training table 402 may contain one row per time step. In some aspects, the training table 402 may contain one row per time step per group identifier. For example, when multiple related series are present, the training table 402 may include separate rows for each combination of time step and group identifier. The group identifier may distinguish separate but potentially related time series. For example, the group identifier may be a store identifier, a product identifier, a region, a customer segment, an asset identifier, a channel designation, a combination thereof, and/or the like.

Historical rows in the training table 402 may be used to construct input sequences and corresponding output sequences for model training. The system may use the training table 402 to generate sequential training examples. As described above, the system (e.g., via one or more of the servers 106B, 108B, 110B, the computing device 102, the vector database 156, the assistant application 158, the LLM 160, etc.) may transform a plurality of row-wise time-stamped records into a plurality of sequential training examples without user data preparation. As part of this transformation, the system may determine, based on the date index, a sorted order of the plurality of row-wise time-stamped records. The system may also determine, based on one or more group identifiers, a plurality of segments from the sorted plurality of row-wise time-stamped records. Other examples are possible as well.

Turning now to FIG. 4B, an apply table 404 and a prediction table 406 are shown. The apply table 404 and the prediction table 406 may be used during a predictions phase. The apply table 404 may include recent historical rows covering the apply window 302 described with respect to FIG. 3. The apply table 404 may include a date field, one or more feature fields, and, where applicable, historical target values. The apply table 404 may provide recent context during inference to a trained multivariate time series forecasting model executed by one or more of the servers 106B, 108B, 110B and/or the computing device 102.

The prediction table 406 may store output records corresponding to the forecast window 304 described with respect to FIG. 3. The prediction table 406 may include future dates. The prediction table 406 may include one or more predicted target values. The prediction table 406 may include one or more uncertainty values. The prediction table 406 may include one or more scenario identifiers. The one or more scenario identifiers may distinguish different what-if scenarios. For example, different scenario identifiers may correspond to different future feature value configurations.

A forecast gap may separate the last row of the apply table 404 from the first future date represented in the prediction table 406. The forecast gap may correspond to the forecast gap 308 described with respect to FIG. 3. At inference time, for example, one or more of the servers 106B, 108B, 110B, the computing device 102, the vector database 156, the assistant application 158, and/or the LLM 160 may combine the apply table 404 with known future feature values for the forecast gap and the forecast window, and may produce one or more prediction rows for each requested group identifier.

The transformation from the apply table 404 to the prediction table 406 may illustrate how one or more of the servers 106B, 108B, 110B and/or the computing device 102, executing the trained multivariate time series forecasting model, transform recent historical context into future predictions. For time series forecasting, a set of rows in the apply table 404 may contribute together to the forecast of a sequence of values in the prediction table 406. This relationship may differ from regular predictions. In regular predictions, one row in apply data may correspond to one row in prediction data. In time series forecasting, multiple rows in the apply table 404 may contribute to multiple rows in the prediction table 406. Other examples are possible as well.

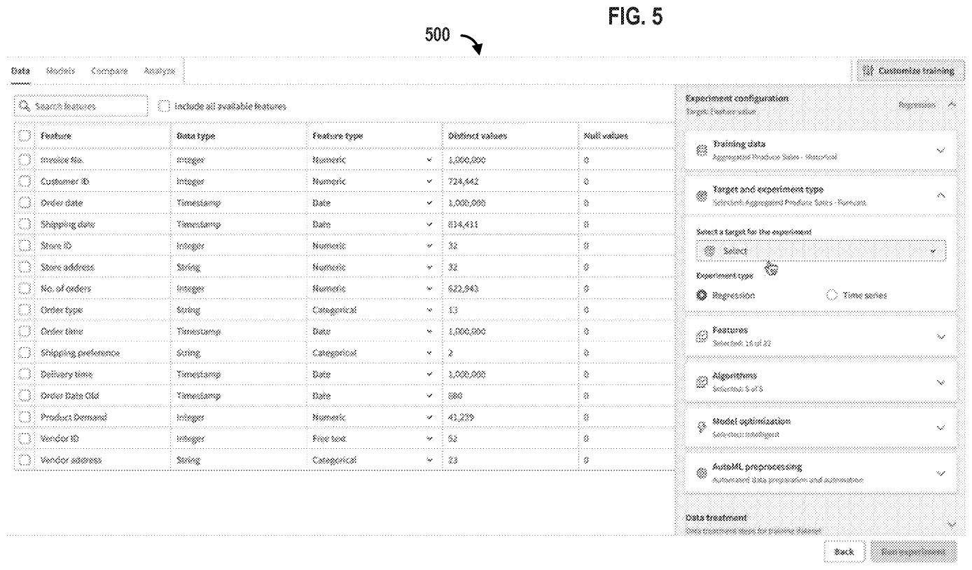

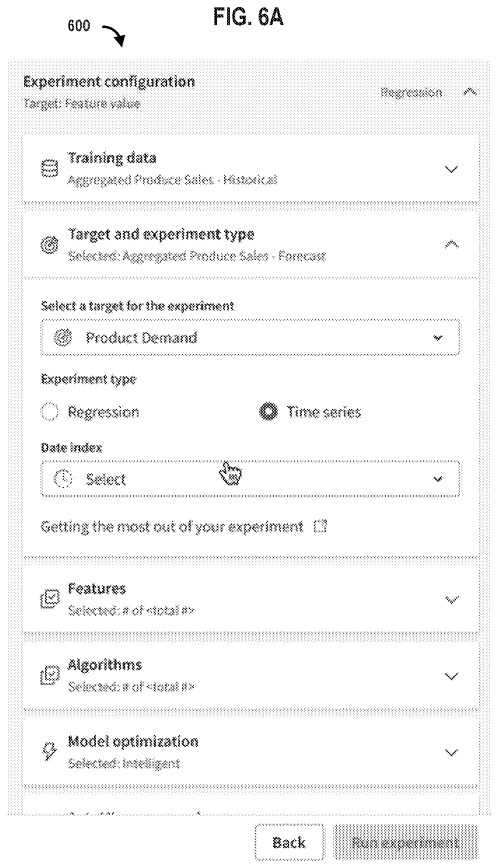

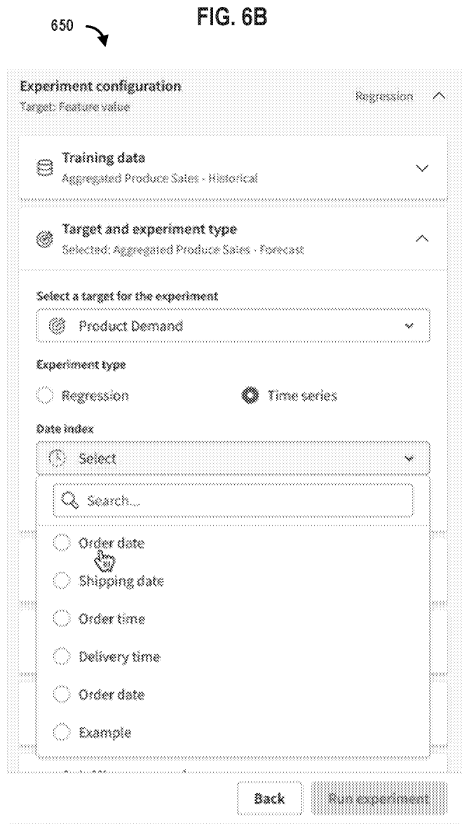

Referring to FIGS. 5 through 6B, an exemplary embodiment of the invention is illustrated. In this example, a user configures a multivariate time series forecasting experiment through a series of interfaces provided by an automated machine learning platform (e.g., implemented by the systems 100 and/or 150). As shown in FIG. 5, the user begins at an experiment-configuration interface 500. The experiment-configuration interface 500 may present a dataset view on one side listing candidate features along with their data types, feature types, distinct values, and null values. An experiment-configuration panel on another side may include sections for training-data selection, target and experiment type selection, features selection, algorithms selection, model optimization, AutoML preprocessing, and data treatment. The user may select a source dataset, such as aggregated produce sales data stored in one or more of the data stores 106, 108, 110 of the system 100, and may select a target variable for the experiment. The user may select a time series experiment type instead of a regression experiment type, as one example.

Prior to or as part of presenting the experiment-configuration interface 500, the system 100 may generate a data profile for one or more candidate features of the source dataset. The data profile may be generated by the ML module 102A, by the associative engine 170, by one or more of the servers 106B, 108B, 110B, a combination thereof, and/or the like. The data profile may include, for each candidate feature, at least one of a data type, a feature type, a distinct value count, a null value count, a null density, a minimum value, a maximum value, a mean value, a median value, a standard deviation, a cardinality classification, a temporal coverage indicator, or one or more other descriptive statistics. As used herein, a ‘data type’ refers to a representation type of values within a field, such as a string, an integer, a floating-point number, a Boolean, a timestamp, a date, or another representational format. A ‘feature type’ refers to a higher-level classification of a field for analytical purposes, such as a categorical feature, a continuous feature, a datetime feature, an identifier feature, a target-eligible feature, a group-eligible feature, a combination thereof, and/or the like. The feature type may be inferred from the data type, the distinct value count, the cardinality classification, the null density, the relationship of the field to one or more other fields in a data model maintained by the associative engine 170, a combination thereof, and/or the like. For example, a field having a string data type, a moderate distinct value count, and a low null density may be inferred to be a categorical feature. As another example, a field having a floating-point data type, a high distinct value count, and a substantially continuous distribution may be inferred to be a continuous feature. Other examples are possible as well.

The system 100 may compute the data profile by performing one or more passes over the source dataset. In some aspects, the associative engine 170 may compute one or more elements of the data profile based on the symbol tables maintained by the associative engine 170. For example, the distinct value count for a given field may be determined directly from a number of entries in the symbol table corresponding to that field, without scanning the underlying data table. Similarly, the cardinality classification for a given field may be derived from a bit-width of the bit-stuffed pointers in the data table corresponding to that field. The data profile may be surfaced via the experiment-configuration interface 500 of FIG. 5 as a dataset view. The dataset view may list, for each candidate feature, a feature name and one or more elements of the data profile. The dataset view may further surface one or more candidate selections for the target value, the date index, the one or more group identifiers, and the one or more future features. The candidate selections may be ranked, filtered, color-coded, or otherwise visually distinguished based on one or more suitability scores derived from the data profile. Other examples are possible as well.

In some aspects, the system 100 may identify, based on the data profile, one or more candidate target values and may surface the one or more candidate target values via the experiment-configuration interface 500. A candidate target value may be a field for which (i) the feature type is continuous or numeric, (ii) the null density is below a configurable threshold, (iii) the variance exceeds a configurable threshold, and (iv) the field is associated, in a data model maintained by the associative engine 170, with at least one date/time field. The one or more candidate target values may be ranked according to one or more ranking criteria, including association strength with the date index in the data model, completeness of historical observations, distinctiveness from identifier-type fields, a combination thereof, and/or the like. The system 100 may surface a ranked list of the one or more candidate target values via the experiment-configuration interface 500 and may receive a confirmation of a top-ranked candidate target value or a user override selecting a different target value. Other examples are possible as well.

In some aspects, the system 100 may identify, based on the data profile, one or more candidate group identifiers and may surface the one or more candidate group identifiers via the experiment-configuration interface 500. A candidate group identifier may be a field for which (i) the feature type is categorical, (ii) the distinct value count exceeds a lower-bound threshold sufficient to support meaningful segmentation, (iii) the distinct value count is below an upper-bound threshold sufficient to exclude high-cardinality identifier columns such as row identifiers or transaction identifiers, and (iv) the field is associated, in a data model maintained by the associative engine 170, with the target value and with the date index. The one or more candidate group identifiers may be ranked according to one or more ranking criteria, including association strength with the target value in the data model, distinct value count, balance of observations across distinct values, a combination thereof, and/or the like. The system 100 may enforce a maximum number of group identifiers, such as two, as described with respect to FIG. 6A. The system 100 may further surface, via the experiment-configuration interface 500, an explanation indicating why a particular field is or is not eligible as a candidate group identifier. Other examples are possible as well.

Continuing the example, the user proceeds to an experiment configuration interface 600 as shown in FIG. 6A. In this example, the user has selected a target variable such as Product Demand and has selected a time series experiment type. The experiment configuration interface 600 may include a control for selecting a date index. The date index may correspond to a date or timestamp field in the dataset and may define time ordering for training and inference. Once the date index is selected, the system (e.g., via the AE Module 102B) may automatically infer a time-step interval based on intervals between successive records in some cases. The experiment configuration interface 600 may present the inferred frequency information and may allow the user to confirm or override the inferred time-step interval. The platform may also populate default values for one or more temporal parameters. For example, the platform may set an apply window length to two times a forecast window and may surface the default values to the user for confirmation or modification. Other examples are possible as well.

Once the date index is selected via the experiment configuration interface 600 of FIG. 6A, the system 100 may determine and surface one or more date-range characteristics of the source dataset. The date-range characteristics may include an overall minimum timestamp, an overall maximum timestamp, an overall date range, a per-series minimum timestamp, a per-series maximum timestamp, a per-series date range, a per-series observation count, a coverage ratio reflecting a fraction of expected time steps for which observations are present, a gap profile identifying one or more intervals within a series for which no observations are present, a combination thereof, and/or the like. As used herein, a ‘series’ refers to a sequence of observations within the source dataset that share a common combination of group identifier values. The system 100 may compute the date-range characteristics using the associative engine 170 by selecting, for each combination of group identifier values, the rows associated with that combination in a data model maintained by the associative engine 170, and applying one or more aggregation operations to the timestamps in the selected rows, such as a min operation, a max operation, a count operation, a gap-detection operation, a combination thereof, and/or the like. The date-range characteristics may be surfaced via the experiment configuration interface 600 as a summary table, a heatmap of per-series coverage, a histogram of per-series observation counts, a combination thereof, and/or the like. Other examples are possible as well.

The system 100 may infer the time step 306 by computing, for one or more pairs of successive timestamps within a series, an interval between the successive timestamps. The system 100 may aggregate the computed intervals across one or more series using a statistical measure such as a mode, a median, a most-common-interval, a weighted average, a combination thereof, and/or the like. As used herein, an ‘inferred time step’ refers to a time-step interval determined by the system 100 based on the computed intervals. The inferred time step may correspond to a calendar-aware granularity, such as a daily granularity, a weekly granularity, a monthly granularity, a quarterly granularity, an hourly granularity, a sub-hourly granularity, a business-day granularity, a calendar-day granularity, a combination thereof, and/or the like. In some aspects, the system 100 may detect calendar-related variability in the intervals, such as daylight-saving-time transitions, month-end length variation, leap-year adjustments, weekend-versus-weekday differences, holiday-related gaps, a combination thereof, and/or the like, and may normalize the computed intervals to a calendar-aware granularity prior to aggregation. Other examples are possible as well.

The system 100 may further determine a confidence value associated with the inferred time step. The confidence value may be based on a dispersion of the computed intervals around the inferred time step, a fraction of computed intervals that match the inferred time step, a consistency of the inferred time step across series, a combination thereof, and/or the like. The system 100 may surface, via the experiment configuration interface 600, the inferred time step, the confidence value, and a control for confirming or overriding the inferred time step. When the confidence value is below a configurable threshold, the system 100 may surface a warning indicating that the source dataset is temporally irregular and that a manual time-step selection or one or more pre-processing transformations may be appropriate. Other examples are possible as well.

In some aspects, the system 100 may populate one or more default values for one or more temporal parameters of the experiment based on the inferred time step, the date-range characteristics, or a combination thereof. As examples, the system 100 may set a default forecast window based on the inferred time step, such as approximately thirty time steps for a daily granularity, approximately twelve time steps for a weekly granularity, approximately twelve time steps for a monthly granularity, approximately four time steps for a quarterly granularity, approximately twenty-four time steps for an hourly granularity, a combination thereof, and/or the like. The system 100 may set a default apply window length to a multiple of the forecast window, such as two times the forecast window, three times the forecast window, or another configurable multiple. The system 100 may set a default forecast gap based on a detected reporting delay, a procurement lead time, an operational lag, a combination thereof, and/or the like. For example, when one or more recent timestamps are absent from one or more series relative to the overall maximum timestamp, the system 100 may infer a reporting delay and may set the default forecast gap based on the inferred reporting delay. The one or more default values may be surfaced via the experiment configuration interface 600 for confirmation or modification by a user. Other examples are possible as well.

Once the date index is selected, the experiment configuration interface 600 may expose additional controls for configuring a forecast window defining a number of future time steps for which predictions are to be generated, a forecast gap representing an offset between an end of an apply window and a start of the forecast window, and/or an apply window spanning a selected number of historical time steps to provide a model with recent context during inference. The additional controls may also include controls for designating one or more group identifiers that distinguish separate but potentially related time series, and one or more future features comprising feature values known in advance for one or more future time steps. As used herein, a ‘future feature’ refers to a feature whose values are known, estimated, or otherwise made available in advance for one or more future time steps, such as a promotion flag, a discount amount, a shelf placement designation, a holiday indicator, a marketing schedule, a weather forecast, a combination thereof, and/or the like. Other examples are possible as well.

The experiment configuration interface 600 may validate whether sufficient historical observations exist for the requested apply window and forecast window and may present warnings or suggestions when the dataset is sparse or irregular. The experiment configuration interface 600 may include a run experiment button for launching the configured experiment. In some aspects, the platform may allow a maximum of two group identifiers to be configured for a time series experiment. Only categorical columns may be selected as group identifiers, for example. The system may validate group identifier configurations when a user initiates an experiment run. In some aspects, the system may validate the one or more group identifiers based on associations maintained by the associative engine 170 between a plurality of fields of the dataset. The associative engine 170 may determine whether a selected group identifier is associated, in a data model maintained by the associative engine 170, with the target value. When a selected group identifier is not associated with the target value in the data model, the system may surface, via the experiment configuration interface 600, a warning indicating that the selected group identifier may not be suitable for the forecasting experiment. The warning may include an explanation of the missing or weak association and may suggest one or more alternative group identifiers that have stronger associations with the target value in the data model. Other examples are possible as well.

In some aspects, the system 100 may classify the source dataset as sparse, irregular, or otherwise unsuitable for one or more temporal configurations based on one or more criteria derived from the data profile, the date-range characteristics, the inferred time step, the confidence value, a combination thereof, and/or the like. As used herein, a ‘sparse’ dataset refers to a dataset in which an observation count for one or more series is below a configurable threshold derived from the apply window length, the forecast window, the forecast gap, or a combination thereof. An ‘irregular’ dataset refers to a dataset in which a dispersion of intervals between successive timestamps within one or more series exceeds a configurable threshold, or in which a gap profile of one or more series indicates a number of missing time steps exceeding a configurable threshold. The system 100 may surface, via the experiment configuration interface 600 (e.g., FIG. 6A or FIG. 6B), one or more warnings identifying one or more affected series and indicating one or more remediation options, such as combining series, increasing the apply window length, decreasing the forecast window, performing imputation, excluding one or more series with insufficient observations, a combination thereof, and/or the like. Other examples are possible as well.

The system 100 may perform schema validation across the one or more group identifiers prior to launching the experiment. The training data may be expected to contain rows for one or more combinations of group identifier values at one or more time steps. The system 100 may compute, based on the inferred time step and the date-range characteristics, an expected set of pairs, each pair comprising a combination of group identifier values and a timestamp. The system 100 may compare the expected set to an actual set of pairs present in the source dataset and may identify one or more missing pairs. As used herein, a ‘missing combination’ refers to a pair, comprising a combination of group identifier values and a timestamp, that is expected to be present based on the schema but is not present in the source dataset. The system 100 may surface, via the experiment configuration interface 600, a report identifying one or more missing combinations and may offer one or more imputation options, such as forward fill, backward fill, zero fill, linear interpolation, exclusion of one or more incomplete series, deferring imputation to the trained multivariate time series forecasting model, a combination thereof, and/or the like. Other examples are possible as well.

In the training data, rows may be present for all combinations of the group identifiers for each time step. After a first experiment run, the system may restrict subsequent changes to valid combinations of group identifiers. In some aspects, advanced users may switch how groups are handled internally. One group identifier may be used for internal grouping. Another group identifier may be transformed to columns in a multivariate time series. The manner in which group identifiers are handled internally may affect the characteristics and quality of the resulting model. Other examples are possible as well.

As shown in FIG. 6B, an experiment configuration screen 650 illustrates a state in which the date index selector is expanded to display a dropdown list of candidate timestamp fields from the dataset, such as an order date field, a shipping date field, an order time field, a delivery time field, and other date-type features. When only one timestamp field is present in the dataset, the system may automatically select that field as the date index. When multiple candidate timestamp fields are present, as in FIG. 6B, the system may prompt the user to choose the date index from the displayed candidates. The experiment configuration screen 650 may present inferred frequency information based on intervals between successive records in the dataset and may allow the user to confirm or override the inferred frequency. Other examples are possible as well.

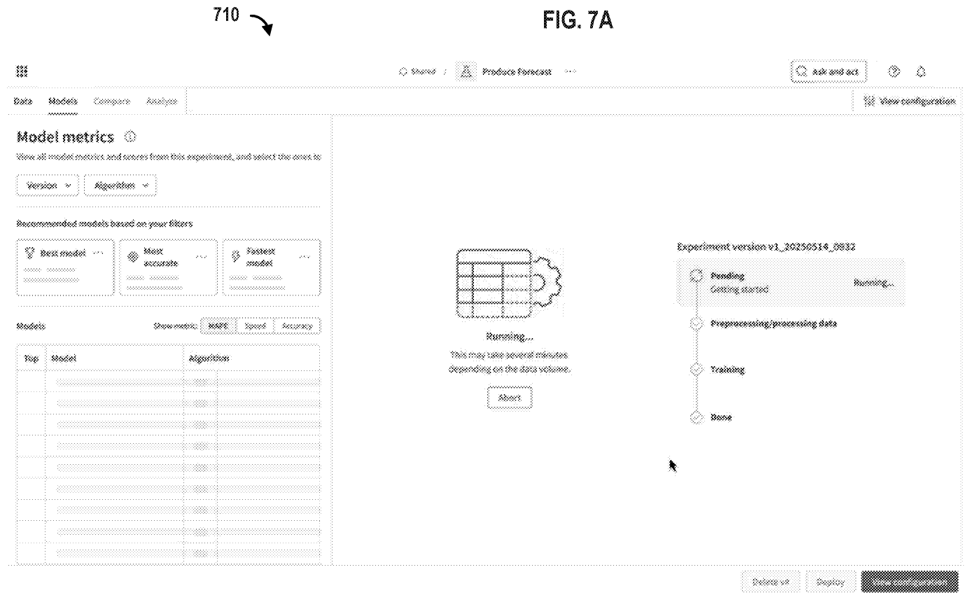

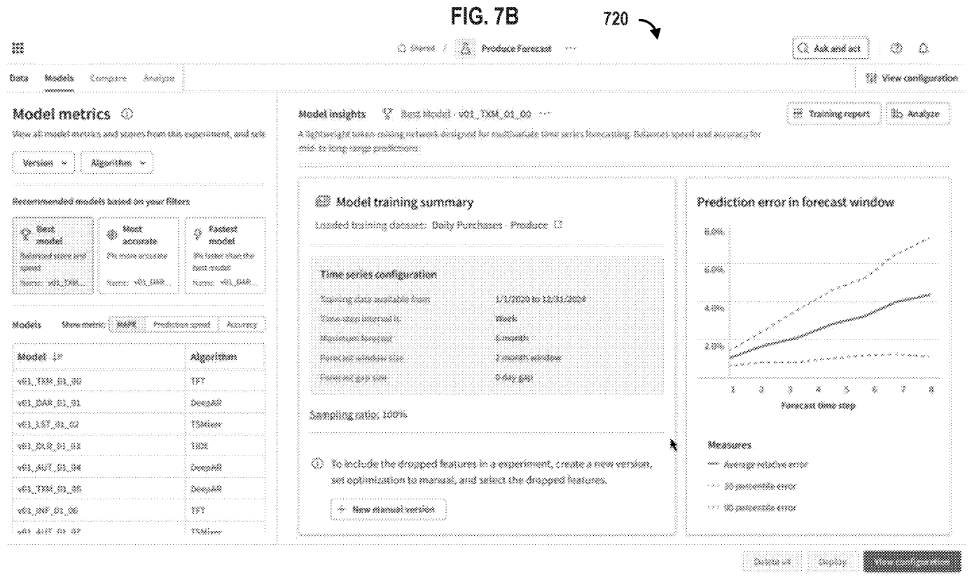

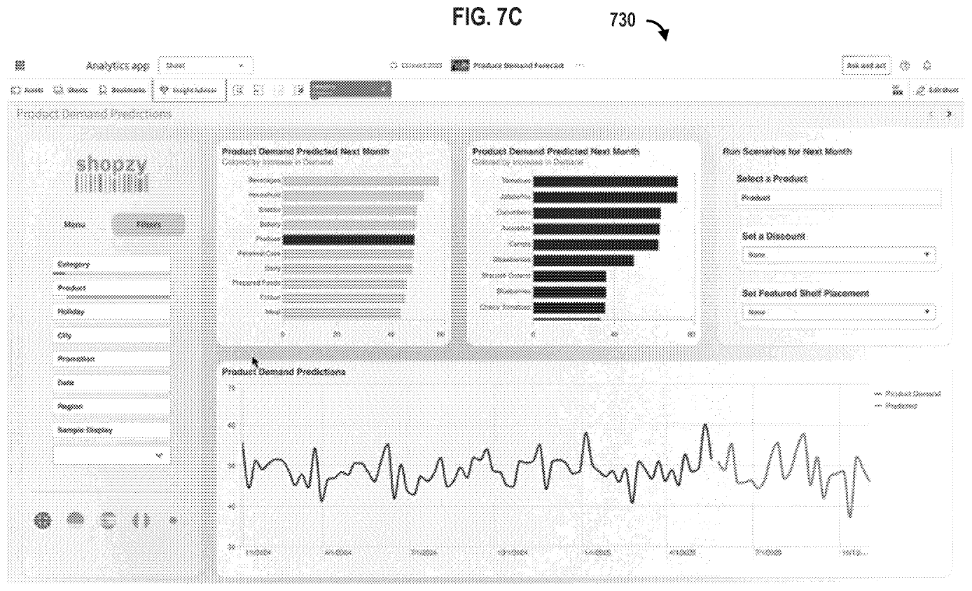

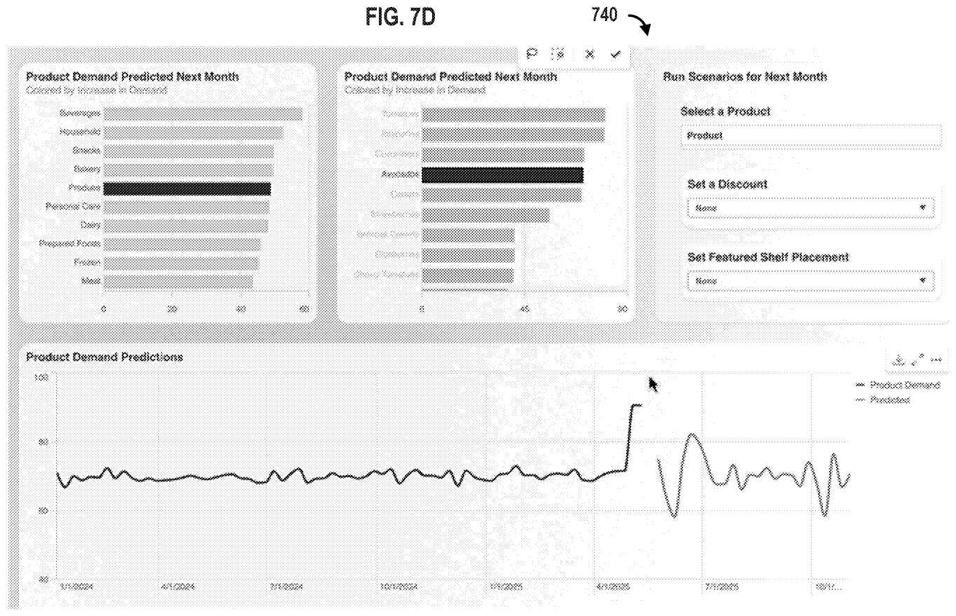

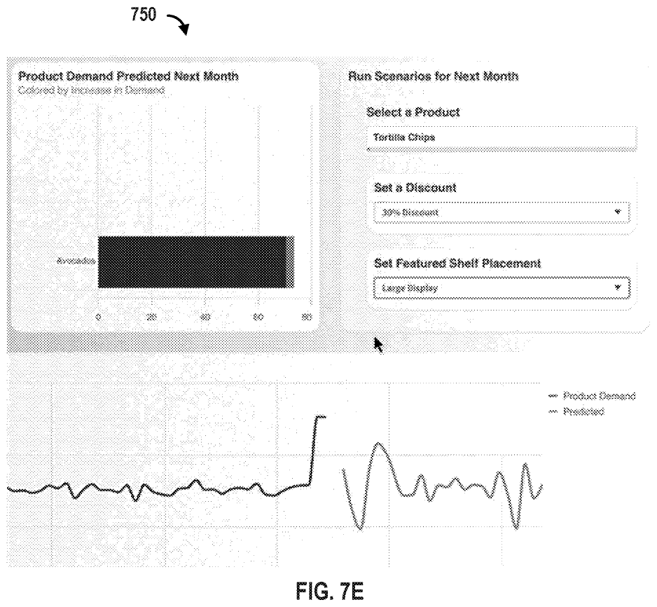

Continuing the example, once the user launches the experiment via the run experiment button, the system trains one or more multivariate time series forecasting models. As shown in FIG. 7A, a training-status interface 710 may present a model-metrics panel on one portion and a training-status panel on another portion. The training-status panel may indicate stages such as pending, preprocessing/processing data, training, and done. The user may monitor progress while the platform constructs sequential training examples from the row-wise time-stamped records, trains one or more candidate forecasting models, and evaluates the candidate forecasting models on one or more validation periods. The system may instantiate multiple candidate architectures, such as Temporal Fusion Transformer models, TiDE models, TSMixer models, or other sequence-model architectures, and may compare the candidate architectures according to one or more performance metrics. The model-metrics panel may reserve space for a ranked list of models and may enable later deployment of a selected model. Other examples are possible as well.

Turning now to FIG. 7B, a model-summary interface 720 may present results after one or more models have been trained. The model-summary interface 720 may list candidate algorithms evaluated during training. Based on the one or more performance metrics, the system may determine a selected model from the plurality of candidate models. As used herein, ‘performance metrics’ refer to one or more measures used to evaluate model quality, such as mean absolute error, mean absolute percentage error, root mean squared error, or other evaluation criteria, and ‘candidate models’ refer to a plurality of machine learning models instantiated and evaluated during an automated model training process, from which a selected model may be determined based on performance metrics. Other examples are possible as well.

The user may then deploy the selected model as a forecasting service. As described herein, a ‘forecasting service’ refers to a set of operations performed by one or more of the servers 106B, 108B, 110B and/or the computing device 102 executing the ML module 102A to receive input data and return predicted target values for one or more future time steps. Once deployed, the trained multivariate time series forecasting model may be invocable through one or more APIs exposed by the servers 106B, 108B, 110B, dashboard connectors integrated with the user interface 200 of FIG. 2, assistant functions provided by the assistant application 158 of the system 150, a combination thereof, and/or the like.

Turning now to FIG. 7C, an analytics application 730 illustrates forecast outputs from the deployed forecasting service integrated into a dashboard. The dashboard, displayed via the user interface 200 of FIG. 2 or a similar interface of the system 100, may include bar charts showing predicted demand at category and product levels. The dashboard may include a line chart overlaying historical demand and predicted demand. The dashboard may also include scenario controls for selecting a product and setting one or more future conditions. As examples, in operation the dashboard may generate one or more requests to the deployed forecasting service hosted by one or more of the servers 106B, 108B, 110B and/or the computing device 102 whenever a user changes a filter, selects a group, or modifies one or more scenario inputs.

Turning now to FIG. 7D, a dashboard view 740 may focus on a selected series, such as a selected product. The dashboard view 740 may show the corresponding forecast in a line chart overlaid with historical values. The dashboard view 740 may also expose controls for creating a scenario by selecting a product, assigning a discount, assigning a shelf placement, or otherwise modifying one or more future feature values. A scenario view 750 as shown in FIG. 7E may illustrate what-if scenario analysis. In this example, the user specifies a scenario involving a selected product, a discount, and a featured shelf placement. The scenario view 750 may display a bar chart and a line chart reflecting a scenario-adjusted forecast for a related product, such as avocados.

The scenario-adjusted forecast may illustrate that the trained multivariate time series forecasting model has learned cross-series relationships from historical multivariate data. For example, a promotion applied to one product may increase predicted demand for a complementary product because the model has learned a relationship between the two products. In some aspects, when a user 153 specifies a hypothetical modification to one or more future feature values associated with a first series, the associative engine 170 may perform associative selection propagation across an in-memory data model to identify one or more second series related to the first series. The associative engine 170 may traverse associations in the data model to determine which series share common group identifier values, common predictor relationships, or other data connections with the first series. The system 150 may then invoke the forecasting service to generate a scenario-adjusted forecast for each of the one or more second series identified by the associative engine 170. The scenario-adjusted forecast for each of the one or more second series may reflect the cross-series relationship learned by the trained multivariate time series forecasting model. The associative engine 170 may surface the identified related series via the user interface 200 of FIG. 2, enabling the user 153 to understand which series are affected by the hypothetical modification. For example, the system 150 may cause the scenario-adjusted forecast for each of the one or more second series to be displayed via the user interface 200 of FIG. 2. The scenario analysis may also be driven by the assistant application 158 described with respect to FIG. 1B. For example, a user may ask the assistant application 158, in natural language, what would happen if a planned promotion were applied to one product next month. The assistant application 158 may translate the request into modified future feature values, invoke the deployed forecasting service hosted by one or more of the servers 106B, 108B, 110B and/or the computing device 102 of the system 100, and present the resulting scenario forecast as a visualization, a natural language response, or both.

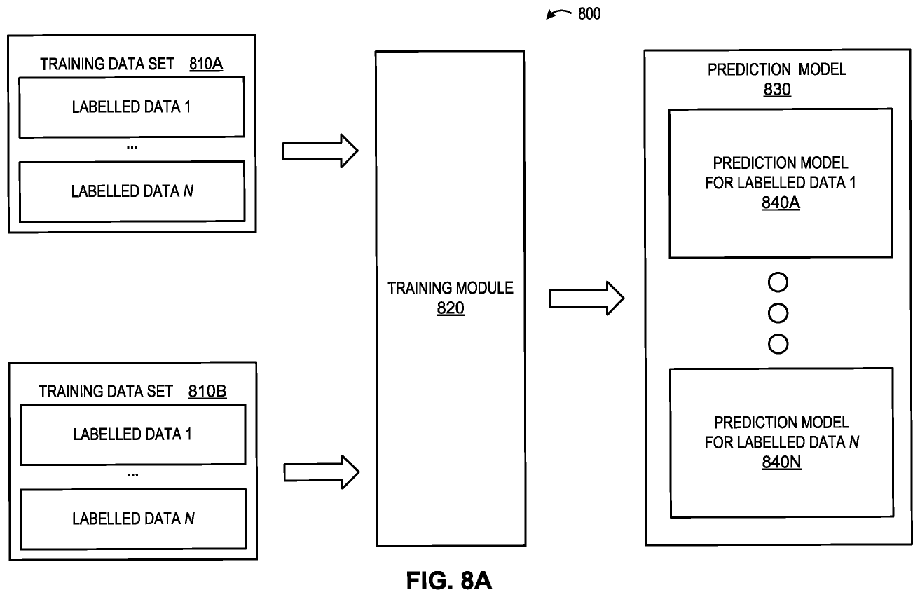

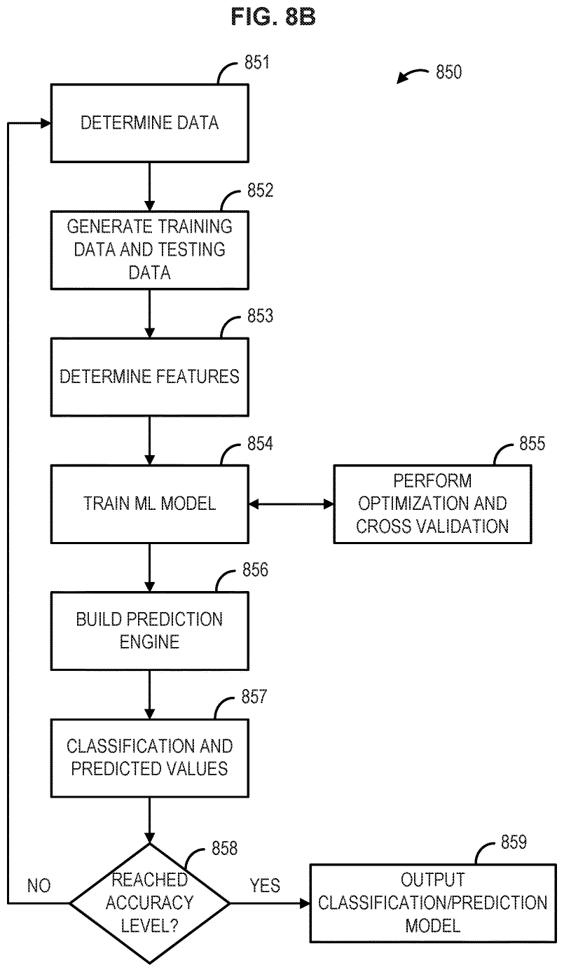

FIG. 8A shows an example training system 800 for machine-learning model training. The training system 800 may be configured to use machine-learning techniques to train, based on an analysis of a plurality of training datasets 810A-810B by a training module 820, a prediction model 830. Some functions of the training system 800 described herein may be performed, for example, by one or more devices/components of the system 100 and/or the system 150, or another computing device in communication therewith. The plurality of training datasets 810A-810B may be associated with input data or annotated data described herein. For example, the first training dataset 810A may comprise one or more labeled data (e.g., labeled data 1-N). Each of the one more labeled data in the first training dataset 810A may comprise one or more inputs (e.g., input features) and corresponding known outputs associated with the one or more inputs. In a forecasting context, the labeled data may comprise row-wise time-stamped records including timestamps, target values, predictor values, group identifiers, known future feature values, a combination thereof, and/or the like. The training system 800 may be used to train one or more multivariate time series forecasting models using sequential training examples derived from the row-wise time-stamped records.

The training datasets 810A, 810B may be based on, or comprise, data stored in one or more devices/components of the system 100 and/or the system 150, or another computing device in communication therewith. Such data may be randomly assigned to the first training dataset 810A, the second training dataset 810B, and/or to a testing dataset. In some implementations, assignment may not be completely random and one or more criteria or methods may be used during the assignment. For example, the first training dataset 810A and/or the second training dataset 810B may be generated based on temporal splits to ensure model validation reflects real-world deployment scenarios where predictions are made on future data. In general, any suitable method may be used to assign the data to the training and/or testing datasets. For multivariate time series forecasting, the train-validation split may preserve temporal order and may use one or more rolling-origin, forward-chaining, or holdout techniques that avoid leakage of future information into training.

The training module 820 may train the prediction model 830 by determining/extracting the features from the first training dataset 810A and/or the second training dataset 810B in a variety of ways. For example, the training module 820 may determine/extract a feature set from the first training dataset 810A and/or the second training dataset 810B. The training module 820 may determine/extract a feature set from the first training dataset 810A and/or the second training dataset 810B to enable automated feature engineering and preprocessing for machine learning model development. The training module 820 may use the feature sets to generate prediction models 840A-840N. In a forecasting context, the training module 820 may treat one or more group identifiers as static or slowly varying context and may treat one or more future features as known-in-advance temporal covariates. Historical observed features may be represented separately from future-known features so that the model can distinguish between values available only in past observations and values available for future time steps.

The first training dataset 810A and/or the second training dataset 810B may be analyzed to determine any dependencies, associations, and/or correlations between features in the first training dataset 810A and/or the second training dataset 810B. The identified correlations may have the form of a list of features that are associated with different labeled predictions. The term “feature,” as used herein, may refer to any characteristic of an item of data that may be used to determine whether the item of data falls within one or more specific categories or within a range. A feature selection technique may comprise one or more feature selection rules. The one or more feature selection rules may comprise a feature occurrence rule. The feature occurrence rule may comprise determining which features in the first training dataset 810A occur over a threshold number of times and identifying those features that satisfy the threshold as candidate features. For example, any features that appear greater than or equal to 8 times in the first training dataset 810A may be considered as candidate features. Any features appearing less than 8 times may be excluded from consideration as a feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the first training dataset 810A to generate a first list of features. A final list of candidate features may be analyzed according to additional feature selection techniques to determine one or more candidate feature groups (e.g., groups of features that may be used to determine a prediction).

Any suitable computational technique may be used to identify the candidate feature groups using any feature selection technique such as filter, wrapper, and/or embedded methods. One or more candidate feature groups may be selected according to classifiers and/or a statistical method. The classifiers and/or statistical method may include, for example, Pearson's correlation, linear discriminant analysis, analysis of variance (ANOVA), chi-square, combinations thereof, and the like. The selection of features according to filter methods are independent of any machine-learning algorithms used by the training system 800. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the prediction model 830 using the subset of features. Based on the inferences that may be drawn from a previous model, features may be added and/or deleted from the subset. Wrapper methods include, for example, forward feature selection, backward feature elimination, recursive feature elimination, combinations thereof, and the like.

For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features.

Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 820 has generated a feature set(s), the training module 820 may generate the prediction models 840A-840N based on the feature set(s). A machine-learning-based prediction model (e.g., any of the prediction models 840A-840N) may refer to a complex mathematical model for the prediction of one or more outcomes through automated machine learning processes. The complex mathematical model for the prediction may be generated using machine-learning techniques as described herein. For example, a machine-learning-based iterative learning control model may repeat one or more AutoML experiments/scenarios. The training module 820 may use the feature sets extracted from the first training dataset 810A and/or the second training dataset 810B to build the prediction models 840A-840N. In some examples, the prediction models 840A-840N may be combined into a single prediction model 830 (e.g., an ensemble model). Similarly, the prediction model 830 may represent a single model containing a single or a plurality of prediction models 840A-840N and/or multiple models containing a single or a plurality of prediction models 840A-840N (e.g., an ensemble model).

The extracted features (e.g., one or more candidate features) may be combined in the prediction models 840A-840N that are trained using a machine-learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like.

For multivariate time series forecasting, the candidate models may further include one or more Temporal Fusion Transformer models, one or more TiDE models, one or more TSMixer models, one or more probabilistic autoregressive models, and/or one or more hybrid or ensemble models. The platform may search over architectures, hyperparameters, loss functions, batch sizes, learning rates, regularization settings, and other training parameters. The resulting prediction model 830 may comprise a decision rule or a mapping for each candidate feature in order to assign a prediction to a class. In a forecasting context, the resulting prediction model 830 may output a sequence of predicted target values for one or more future time steps in a forecast window. The prediction model 830 may also output one or more uncertainty values, prediction intervals, or attribution values.

FIG. 8B is a flowchart illustrating an example training method 850 for generating the prediction model 830 using the training module 820. The training module 820 may implement supervised, unsupervised, and/or semi-supervised (e.g., reinforcement based) learning. The method 850 illustrated in FIG. 8B is an example of a supervised learning method; variations of this example of training method may be analogously implemented to train unsupervised and/or semi-supervised machine-learning models. The method 850 may be implemented by one or more devices/components of the system 100 or the system 150, or another computing device in communication therewith via wired or wireless communication. In a forecasting context, the method 850 may be used to train a multivariate time series forecasting model using sequential training examples derived from row-wise time-stamped records.

At step 851, the training method 850 may determine (e.g., access, receive, retrieve, etc.) first training data and second training data (e.g., the training datasets 810A-810B). The first training data and the second training data may each comprise one or more labeled data. The one more labeled data may comprise one or more inputs (e.g., input features) and corresponding known outputs associated with the one or more inputs. The training method 850 may generate, at step 852, a training dataset and a testing dataset. The training dataset and the testing dataset may be generated by randomly assigning data from the first training data and/or the second training data to either the training dataset or the testing dataset. In some implementations, the assignment of data as training or test data may not be completely random. For example, the training dataset and/or the testing dataset may be generated based on temporal splits to ensure model validation reflects real-world deployment scenarios where predictions are made on future data.

The training method 850 may determine (e.g., extract, select, etc.), at step 853, a set of features from the first training data. As another example, the training method 850 may determine a set of features from the second training data. The training method 850 may train one or more machine-learning models (e.g., one or more classification models, one or more prediction models, neural networks, deep-learning models, etc.) using the one or more features at step 854. In one example, the machine-learning models may be trained using supervised learning. In another example, other machine-learning techniques may be used, including unsupervised learning and semi-supervised. The machine-learning models trained at step 854 may be selected based on different criteria depending on the problem to be solved and/or data available in the training dataset. For example, machine-learning models may suffer from different degrees of bias. Accordingly, more than one machine-learning model may be trained at step 854, and then optimized, improved, and cross-validated at step 855.

The training method 850 may select one or more machine-learning models to build the prediction model 830 at step 856. The prediction model 830 may be evaluated using the testing dataset. The prediction model 830 may analyze the testing dataset and generate predicted values at step 857. Classification and/or prediction values may be evaluated at step 858 to determine whether such values have achieved a desired accuracy level. Performance of the prediction model 830 may be evaluated in a number of ways based on a number of true positives, false positives, true negatives, and/or false negatives classifications of the plurality of data points indicated by the prediction model 830.

Generally, recall refers to a ratio of true positives to a sum of true positives and false negatives, which quantifies a sensitivity of the prediction model 830. Similarly, precision refers to a ratio of true positives to a sum of true and false positives. When such a desired accuracy level is reached, the training phase ends and the prediction model 830 may be output at step 859; when the desired accuracy level is not reached, however, then a subsequent iteration of the training method 850 may be performed starting at step 851 with variations such as, for example, considering a larger collection of labeled data. The prediction model 830 may be output at step 859.

Once the prediction model 830 is output, the prediction model 830 may be deployed as a forecasting service. As part of the forecasting service, one or more of the servers 106B, 108B, 110B and/or the computing device 102 may receive one or more group identifiers, recent historical rows spanning an apply window, one or more future feature schedules spanning a forecast gap and a forecast window, and optionally one or more scenario identifiers or confidence parameters. One or more of the servers 106B, 108B, 110B and/or the computing device 102 may return one or more predicted target values for one or more future dates. The forecasting service may be invoked by dashboards, enterprise planning systems, external applications, or assistant applications. In some aspects, the deployed model may be periodically or conditionally retrained using updated historical data while preserving one or more experiment settings, including a selected target variable, date index, forecast window, forecast gap, apply window length, group identifiers, future features, a combination thereof, and/or the like.

The present methods and systems may be computer-implemented. FIG. 9 shows a block diagram depicting a system/environment 900 comprising non-limiting examples of a computing device 901 and a server 902 connected through a network 904. Either of the computing device 901 or the server 902 may be a computing device, such as any of the devices of the system 100 shown in FIG. 1A and/or any of the any of the devices of the system 150 shown in FIG. 1B. In a forecasting context, the server 902 may host the ML module 102A described with respect to FIG. 1A and may execute forecasting-related services including model training, model deployment, and forecast serving. In an aspect, some or all steps of any described method may be performed on a computing device as described herein.

The computing device 901 may comprise one or multiple computers configured to store application data 939, and/or the like. The server 902 may comprise one or multiple computers configured to store assistant data 929. Multiple servers 902 may communicate with the computing device 901 via the through the network 904. The computing device 901 and the server 902 may be a digital computer that, in terms of hardware architecture, generally includes a processor 908, system memory 910, input/output (I/O) interfaces 912, and network interfaces 914. These components (908, 910, 912, and 914) are communicatively coupled via a local interface 916. The local interface 916 may be, for example, but not limited to, one or more buses or other wired or wireless connections, as is known in the art. The local interface 916 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 908 may be a hardware device for executing software, particularly that stored in system memory 910. The processor 908 may be any custom made or commercially available processor, a central processing unit (CPU), an auxiliary processor among several processors associated with the computing device 901 and the server 902, a semiconductor-based microprocessor (in the form of a microchip or chip set), or generally any device for executing software instructions. When the computing device 901 and/or the server 902 is in operation, the processor 908 may execute software stored within the system memory 910, to communicate data to and from the system memory 910, and to generally control operations of the computing device 901 and the server 902 pursuant to the software. The I/O interfaces 912 may be used to receive user input from, and/or for providing system output to, one or more devices or components. User input may be provided via, for example, a keyboard and/or a mouse. System output may be provided via a display device and a printer (not shown).

I/O interfaces 912 may include, for example, a serial port, a parallel port, a Small Computer System Interface (SCSI), an infrared (IR) interface, a radio frequency (RF) interface, and/or a universal serial bus (USB) interface. The network interface 914 may be used to transmit and receive from the computing device 901 and/or the server 902 on the network 904. The network interface 914 may include, for example, a 10 BaseT Ethernet Adaptor, a 10 BaseT Ethernet Adaptor, a LAN PHY Ethernet Adaptor, a Token Ring Adaptor, a wireless network adapter (e.g., WiFi, cellular, satellite), or any other suitable network interface device. The network interface 914 may include address, control, and/or data connections to enable appropriate communications on the network 904. The system memory 910 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 910 may incorporate electronic, magnetic, optical, and/or other types of storage media.

Note that the system memory 910 may have a distributed architecture, where various components are situated remote from one another, but may be accessed by the processor 908. The software in system memory 910 may include one or more software programs, each of which comprises an ordered listing of executable instructions for implementing logical functions. In the example of FIG. 9, the software in the system memory 910 of the computing device 901 may comprise the application data 939, the client application 925, and a suitable operating system (O/S) 918. In the example of FIG. 9, the software in the system memory 910 of the server 902 may comprise the assistant data 929, the assistant application 926, and a suitable operating system (O/S) 918. The assistant application 926 may correspond to the assistant application 158 described with respect to FIG. 1B. The assistant data 929 may include forecast results, experiment configuration metadata, model artifacts, scenario templates, other forecasting-related data, a combination thereof, and/or the like. The client application 925 may implement a browser, dashboard application, or administration console by which a user configures experiments, reviews model metrics, requests forecasts, or performs scenario analysis. The operating system 918 essentially controls the execution of other computer programs and provides scheduling, input-output control, file and data management, memory management, and communication control and related services. For purposes of illustration, application programs and other executable program components such as the operating system 918 are shown herein as discrete blocks, although it is recognized that such programs and components may reside at various times in different storage components of the computing device 901 and/or the server 902.

An implementation of the system/environment 900 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

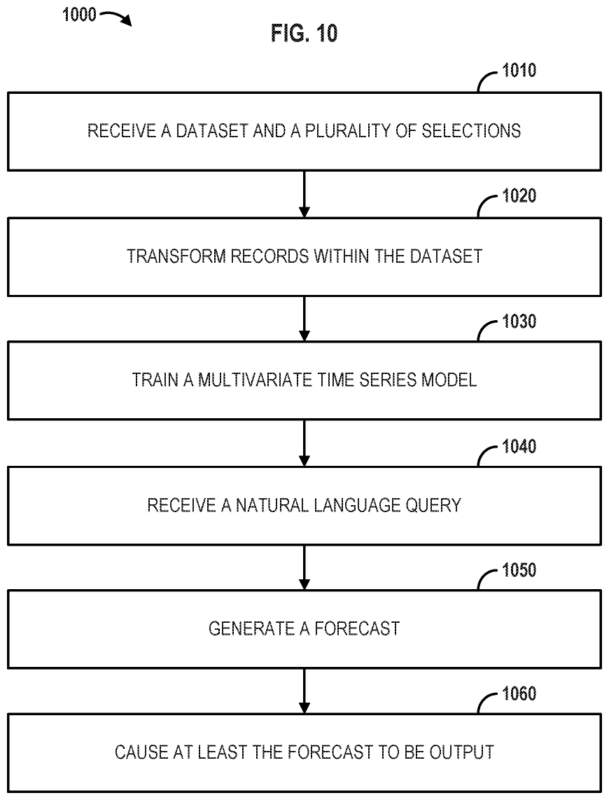

FIG. 10 illustrates a method 1000 for multivariate time series forecasting. The method 1000 may be performed by one or more computing devices. For example, the method 1000 may be performed by the computing device 102 described with respect to FIG. 1A. The method 1000 may be performed by the system 150 described with respect to FIG. 1B. The method 1000 may be performed by the server 902 and/or the computing device 901 described with respect to FIG. 9. An apparatus may comprise a processor and memory storing instructions. The instructions, when executed by the processor, may cause the apparatus to perform the method 1000. A non-transitory computer-readable medium may store instructions that, when executed by a processor, cause the processor to perform operations comprising the method 1000.

At step 1010, the method 1000 may include receiving a dataset and a plurality of selections. The dataset may comprise a plurality of row-wise time-stamped records, where each record may comprise a timestamp, a target value, and one or more predictor values. The dataset may be stored in one or more of the data stores 106, 108, 110 of the system 100 shown in FIG. 1A. The plurality of selections may be received via a user interface, such as the user interface 200 described with respect to FIG. 2. The plurality of selections may include a selection of the target value, a selection of a date index (e.g., corresponding to a date field in the training table 402 of FIG. 4A), and a selection of a time series experiment type. The dataset and the plurality of selections may be received at an automated machine learning platform, such as the system 100 of FIG. 1A and/or the system 150 of FIG. 1B. The plurality of selections may further include a selection of one or more future features comprising feature values known in advance for one or more future time steps.

At step 1020, the method 1000 may include transforming records within the dataset. The system 100 may transform the plurality of row-wise time-stamped records into a plurality of sequential training examples without user data preparation. The transformation may be based on the selection of the time series experiment type. Transforming the plurality of row-wise time-stamped records may comprise determining, based on the date index, a sorted order of the plurality of row-wise time-stamped records. The sorted records may be segmented, based on one or more group identifiers (e.g., corresponding to group identifiers in the training table 402 of FIG. 4A), into a plurality of segments. From the plurality of segments, a plurality of input-output sequences may be generated based on an apply window length (e.g., corresponding to the apply window 302 of FIG. 3) and a forecast window (e.g., corresponding to the forecast window 304 of FIG. 3). The transforming may be performed without requiring manual data reshaping, manual tensor construction, or model-specific configuration by a user.

At step 1030, the method 1000 may include training a multivariate time series model. A trained multivariate time series forecasting model may be generated based on the plurality of sequential training examples. Generating the trained multivariate time series forecasting model may comprise determining, based on one or more performance metrics, a selected model from a plurality of candidate models. The plurality of candidate models may comprise at least one of a Temporal Fusion Transformer model, a TiDE model, or a TSMixer model. The trained multivariate time series forecasting model may be caused to be deployed as a forecasting service hosted by one or more of the servers 106B, 108B, 110B and/or the computing device 102 of the system 100. Causing the trained multivariate time series forecasting model to be deployed as a forecasting service may comprise exposing a programmatic interface via one or more of the servers 106B, 108B, 110B. The programmatic interface may be configured to receive recent historical records for an apply window and future feature values for a forecast gap and a forecast window. The programmatic interface may be configured to return predicted target values to a requesting component, such as the user interface 200 of FIG. 2, the assistant application 158 of the system 150, or the client application 925 of FIG. 9.

At step 1040, the method 1000 may include receiving a natural language query. The natural language query may be received at an assistant application. For example, the natural language query may be received at the assistant application 158 described with respect to FIG. 1B. The natural language query may request a forecast for a target variable configured via the experiment configuration interface 600 of FIG. 6A, such as Product Demand. The natural language query may reference one or more group identifiers designated via the experiment configuration interface 600, such as a specific product, store, or region. For example, a user may ask ‘How popular will avocados be next month?’ or ‘What is the predicted demand for chips in the Northeast region?’ The natural language query may also request a scenario-adjusted forecast by specifying a hypothetical modification to one or more future features configured via the experiment configuration interface 600 of FIG. 6A. For example, a user may ask ‘What happens to avocado demand if we run a promotion on chips?’ The natural language query may reference temporal parameters such as the forecast window or the date index selected via the experiment configuration screen 650 of FIG. 6B. In some aspects, the assistant application 158 may query the associative engine 170 to obtain a current selection state prior to converting the natural language query into a parameterized forecasting request. The current selection state may be maintained by one or more state vectors of the associative engine 170 and may identify, for each of a plurality of fields of the dataset, values that are at least one of selected, possible, alternative, or excluded based on one or more user selections.

At step 1050, the method 1000 may include generating a forecast. The forecast may be generated based on the natural language query received at step 1040. To generate the forecast, the assistant application (e.g., the assistant application 158 of the system 150 shown in FIG. 1B) may convert the natural language query into a parameterized forecasting request identifying a specific product, region, horizon, or scenario modification. In some aspects, the parameterized forecasting request may be generated based on the current selection state maintained by the associative engine 170. The parameterized forecasting request may be informed by one or more values identified as selected by the one or more state vectors of the associative engine 170. The assistant application 158 may then invoke the deployed forecasting service to obtain forecast values. In some aspects, invoking the forecasting service may comprise receiving, from the associative engine 170, one or more aggregated predictor values computed using a hypercube data structure organized by at least one of the one or more group identifiers and a temporal dimension defined by the date index. To invoke the deployed forecasting service, the assistant application 158 may transmit a request to one or more of the servers 106B, 108B, 110B at which the service is resident. The request may comprise one or more group identifiers extracted from the natural language query or obtained from the current selection state of the associative engine 170, recent historical records retrieved from one or more of the data stores 106, 108, 110 to populate an apply window, and future feature values for a forecast gap and a forecast window.

One or more of the servers 106B, 108B, 110B executing the ML module 102A may process the request by applying the historical records and the future feature values to the trained multivariate time series forecasting model. The one or more servers may return one or more predicted target values, and optionally one or more uncertainty values or prediction intervals, to the assistant application 158 via the network 104. The large language model 160 of FIG. 1B may then use the returned predicted target values, together with any retrieved contextual information, to formulate a natural language response that includes or explains the forecast values. In some aspects, the response to the natural language query may comprise both (i) one or more deterministic values computed by the associative engine 170 and (ii) one or more probabilistic predicted target values returned by the forecasting service. The associative engine 170 may provide deterministic calculations that are independent of the large language model 160 used by the assistant application 158 to formulate the response. The one or more deterministic values may include historical aggregates, year-over-year comparisons, current selection context, exclusion state information, a combination thereof, and/or the like. The deterministic values computed by the associative engine 170 may provide governed, traceable context alongside the probabilistic forecast values, enabling the user 153 to understand both the historical baseline and the predicted future values. Other examples are possible as well.

As part of the forecasting service, one or more of the servers 106B, 108B, 110B may receive one or more group identifiers, recent historical rows spanning an apply window (e.g., the apply window 302 of FIG. 3), and one or more future feature schedules spanning a forecast gap (e.g., the forecast gap 308 of FIG. 3) and a forecast window (e.g., the forecast window 304 of FIG. 3). The one or more servers may return predicted target values in a format corresponding to the prediction table 406 described with respect to FIG. 4B. In some aspects, contextual information for the natural language query may be retrieved from the vector database 156 of the system 150 shown in FIG. 1B. The vector database 156 may store embeddings derived from structured content or unstructured content related to forecasting, as described with respect to the data conversion 154 of FIG. 1B. The contextual information may be provided to the large language model 160 of FIG. 1B, which may formulate a response that includes or explains the forecast values.

At step 1060, the method 1000 may include causing at least the forecast to be output. The assistant application (e.g., the assistant application 158 of FIG. 1B) may be caused to send a response to the natural language query, wherein the response comprises the forecast. In some aspects, the response may comprise both (i) one or more deterministic values computed by the associative engine 170 and (ii) one or more probabilistic predicted target values returned by the forecasting service. The one or more deterministic values may provide governed, traceable context alongside the forecast. In some aspects, the response may include a visualization of the forecast displayed via the user interface 200 of FIG. 2. The visualization may comprise a line chart (e.g., the chart 202 of FIG. 2) overlaying historical values and predicted values. The visualization may also comprise a bar chart showing predicted values at category and product levels. In some aspects, the response may further comprise one or more prediction intervals or confidence intervals for one or more future time steps within the forecast window 304 of FIG. 3. The forecast may be served with latency sufficient to support interactive updates of a dashboard in response to user filtering or selection.

In some aspects, the method 1000 may further support scenario analysis. A user (e.g., one of the users 153 of the system 150 shown in FIG. 1B) may specify a hypothetical modification to one or more future features via the user interface 200 of FIG. 2 or via a natural language query to the assistant application 158. The modified future feature values may be combined with baseline historical records from the apply table 404 of FIG. 4B and baseline future feature schedules.

The trained multivariate time series forecasting model may be re-executed to generate a scenario-adjusted forecast over the forecast window 304 of FIG. 3. The scenario-adjusted forecast may reflect cross-series relationships learned by the trained multivariate time series forecasting model from training data organized as described with respect to the training table 402 of FIG. 4A. For example, the scenario-adjusted forecast may reflect an adjusted predicted demand for a complementary product in response to a hypothetical modification specified for a first series. The hypothetical modification may comprise at least one of a promotional discount, a shelf-placement designation, a price change, a marketing campaign indicator, or a holiday-related indicator. In some aspects, a plurality of scenario definitions and corresponding scenario forecasts may be stored. Concurrent comparison of the plurality of scenario forecasts with a baseline forecast may be enabled. The scenario definition may be received through a dashboard control or a conversational assistant (e.g., the assistant application 158 of FIG. 1B), which may translate user input into the hypothetical modification to one or more future features. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving a dataset comprising a plurality of row-wise time-stamped records, each record of the plurality of row-wise time-stamped records comprising a timestamp, a target value, and one or more predictor values;
receiving, via a user interface, a selection of the target value, a date index, and a time series experiment type;
transforming, based on the selection of the time series experiment type, the plurality of row-wise time-stamped records into a plurality of sequential training examples without user data preparation;
generating, based on the plurality of sequential training examples, a trained multivariate time series forecasting model;
causing the trained multivariate time series forecasting model to be deployed as a forecasting service;
receiving, at an assistant application, a natural language query requesting a forecast;
generating, based on the natural language query, a forecast by causing the assistant application to invoke the forecasting service; and
causing the assistant application to send a response to the natural language query, wherein the response comprises the forecast.

2. The method of claim 1, wherein generating the forecast comprises:
querying an associative engine to obtain a current selection state, wherein the associative engine maintains one or more state vectors that identify, for each of a plurality of fields of the dataset, values that are at least one of selected, possible, alternative, or excluded based on one or more user selections; and
generating, based on the current selection state, a parameterized forecasting request, wherein the parameterized forecasting request is informed by one or more values identified as selected by the one or more state vectors.

3. The method of claim 1, wherein the dataset is loaded into an associative engine that maintains the dataset in an in-memory data model comprising one or more data tables and one or more symbol tables, wherein the one or more data tables comprise bit-stuffed pointers indexing distinct values stored in the one or more symbol tables.

4. The method of claim 1, wherein causing the assistant application to invoke the forecasting service comprises receiving, from an associative engine, one or more aggregated predictor values computed using a hypercube data structure organized by at least one group identifier and a temporal dimension defined by the date index, and providing the one or more aggregated predictor values as input to the trained multivariate time series forecasting model.

5. The method of claim 1, wherein the response comprises (i) one or more deterministic values computed by an associative engine and (ii) one or more probabilistic predicted target values returned by the forecasting service, wherein the associative engine provides deterministic calculations that are independent of a large language model used by the assistant application to formulate the response.

6. The method of claim 1, further comprising:
receiving, via the user interface or via the assistant application, a hypothetical modification to one or more future feature values associated with a first series;
causing an associative engine to perform associative selection propagation across an in-memory data model to identify one or more second series related to the first series in the in-memory data model;
invoking the forecasting service to generate a scenario-adjusted forecast for each of the one or more second series; and
causing the scenario-adjusted forecast for each of the one or more second series to be displayed via the user interface.

7. The method of claim 1, further comprising:
identifying, by an associative engine and based on a current selection state, one or more excluded values that are not associated with the current selection state but are associated, in a data model maintained by the associative engine, with one or more selected values; and
invoking the forecasting service to obtain one or more additional predicted target values for the one or more excluded values.

8. A non-transitory computer-readable medium storing processor-executable instructions that, when executed by at least one processor of at least one computing device, cause the at least one processor to:
receive a dataset comprising a plurality of row-wise time-stamped records, each record of the plurality of row-wise time-stamped records comprising a timestamp, a target value, and one or more predictor values;
receive, via a user interface, a selection of the target value, a date index, and a time series experiment type;
transform, based on the selection of the time series experiment type, the plurality of row-wise time-stamped records into a plurality of sequential training examples without user data preparation;
generate, based on the plurality of sequential training examples, a trained multivariate time series forecasting model;
cause the trained multivariate time series forecasting model to be deployed as a forecasting service;
receive, at an assistant application, a natural language query requesting a forecast;
generate, based on the natural language query, a forecast by causing the assistant application to invoke the forecasting service; and
cause the assistant application to send a response to the natural language query, wherein the response comprises the forecast.

9. The non-transitory computer-readable medium of claim 8, wherein the processor-executable instructions that cause the at least one processor to generate the forecast further cause the at least one processor to:
query an associative engine to obtain a current selection state, wherein the associative engine maintains one or more state vectors that identify, for each of a plurality of fields of the dataset, values that are at least one of selected, possible, alternative, or excluded based on one or more user selections; and
generate, based on the current selection state, a parameterized forecasting request, wherein the parameterized forecasting request is informed by one or more values identified as selected by the one or more state vectors.

10. The non-transitory computer-readable medium of claim 8, wherein the dataset is loaded into an associative engine that maintains the dataset in an in-memory data model comprising one or more data tables and one or more symbol tables, wherein the one or more data tables comprise bit-stuffed pointers indexing distinct values stored in the one or more symbol tables.

11. The non-transitory computer-readable medium of claim 8, wherein the processor-executable instructions that cause the at least one processor to cause the assistant application to invoke the forecasting service further cause the at least one processor to receive, from an associative engine, one or more aggregated predictor values computed using a hypercube data structure organized by at least one group identifier and a temporal dimension defined by the date index, and providing the one or more aggregated predictor values as input to the trained multivariate time series forecasting model.

12. The non-transitory computer-readable medium of claim 8, wherein the response comprises (i) one or more deterministic values computed by an associative engine and (ii) one or more probabilistic predicted target values returned by the forecasting service, wherein the associative engine provides deterministic calculations that are independent of a large language model used by the assistant application to formulate the response.

13. The non-transitory computer-readable medium of claim 8, wherein the processor-executable instructions further cause the at least one processor to:
receive, via the user interface or via the assistant application, a hypothetical modification to one or more future feature values associated with a first series;
cause an associative engine to perform associative selection propagation across an in-memory data model to identify one or more second series related to the first series in the in-memory data model;
invoke the forecasting service to generate a scenario-adjusted forecast for each of the one or more second series; and
cause the scenario-adjusted forecast for each of the one or more second series to be displayed via the user interface.

14. The non-transitory computer-readable medium of claim 8, wherein the processor-executable instructions further cause the at least one processor to:
identify, by an associative engine and based on a current selection state, one or more excluded values that are not associated with the current selection state but are associated, in a data model maintained by the associative engine, with one or more selected values; and
invoke the forecasting service to obtain one or more additional predicted target values for the one or more excluded values.

15. An apparatus comprising:
one or more processors; and
memory storing processor-executable instructions that, when executed by the one or more processors, cause the apparatus to:
receive a dataset comprising a plurality of row-wise time-stamped records, each record of the plurality of row-wise time-stamped records comprising a timestamp, a target value, and one or more predictor values;
receive, via a user interface, a selection of the target value, a date index, and a time series experiment type;
transform, based on the selection of the time series experiment type, the plurality of row-wise time-stamped records into a plurality of sequential training examples without user data preparation;
generate, based on the plurality of sequential training examples, a trained multivariate time series forecasting model;
cause the trained multivariate time series forecasting model to be deployed as a forecasting service;
receive, at an assistant application, a natural language query requesting a forecast;
generate, based on the natural language query, a forecast by causing the assistant application to invoke the forecasting service; and
cause the assistant application to send a response to the natural language query, wherein the response comprises the forecast.

16. The apparatus of claim 15, wherein the processor-executable instructions that cause the apparatus to generate the forecast further cause the apparatus to:
query an associative engine to obtain a current selection state, wherein the associative engine maintains one or more state vectors that identify, for each of a plurality of fields of the dataset, values that are at least one of selected, possible, alternative, or excluded based on one or more user selections; and
generate, based on the current selection state, a parameterized forecasting request, wherein the parameterized forecasting request is informed by one or more values identified as selected by the one or more state vectors.

17. The apparatus of claim 15, wherein the dataset is loaded into an associative engine that maintains the dataset in an in-memory data model comprising one or more data tables and one or more symbol tables, wherein the one or more data tables comprise bit-stuffed pointers indexing distinct values stored in the one or more symbol tables.

18. The apparatus of claim 15, wherein the processor-executable instructions that cause the apparatus to cause the assistant application to invoke the forecasting service further cause the apparatus to receive, from an associative engine, one or more aggregated predictor values computed using a hypercube data structure organized by at least one group identifier and a temporal dimension defined by the date index, and providing the one or more aggregated predictor values as input to the trained multivariate time series forecasting model.

19. The apparatus of claim 15, wherein the response comprises (i) one or more deterministic values computed by an associative engine and (ii) one or more probabilistic predicted target values returned by the forecasting service, wherein the associative engine provides deterministic calculations that are independent of a large language model used by the assistant application to formulate the response.

20. The apparatus of claim 15, wherein the wherein the processor-executable further cause the apparatus to:
receive, via the user interface or via the assistant application, a hypothetical modification to one or more future feature values associated with a first series;
cause an associative engine to perform associative selection propagation across an in-memory data model to identify one or more second series related to the first series in the in-memory data model;
invoke the forecasting service to generate a scenario-adjusted forecast for each of the one or more second series; and
cause the scenario-adjusted forecast for each of the one or more second series to be displayed via the user interface.
